(19) United States
(12) Patent Application Publication
(10) Pub. No.: US 2019/0233677 A1
(43) Pub. Date: Aug. 1, 2019

(54) COATING COMPOSITION, ANTIREFLECTION FILM, LAMINATE, METHOD FOR MANUFACTURING LAMINATE, AND SOLAR CELL MODULE

(71) Applicant: FUJIFILM CORPORATION, Tokyo (JP)

(72) Inventors: Hideaki TSUBAKI, Shizuoka (JP); Ayana FUJIMAKI, Shizuoka (JP); Hirotaka KITAGAWA, Shizuoka (JP)

(21) Appl. No.: 16/378,563

(22) Filed: Apr. 9, 2019

Related U.S. Application Data
(63) Continuation of application No. PCT/JP2017/042674, filed on Nov. 28, 2017.

(30) Foreign Application Priority Data
Nov. 30, 2016 (JP) 2016-233496

(51) Int. Cl. C09D 201/10; C09D 7/61; C09D 7/40; B32B 27/18; B32B 7/023

(52) U.S. Cl. CPC C09D 201/10; C09D 7/61; C09D 7/67; B32B 2457/12; B32B 7/023; B32B 2264/102; B32B 2307/42; B32B 27/18

(57) ABSTRACT

Provided are a coating composition including nonionic polymer particles having a number-average primary particle diameter of 5 nm to 200 nm and a hydrolysable silane compound represented by Formula 1, an antireflection film which is a cured substance of the coating composition, a laminate including the antireflection film, a method for manufacturing the laminate, and a solar cell module including the laminate.

In Formula 1, X represents a hydrolysable group or a halogen atom, Y represents a non-hydrolysable group, and n represents an integer of 0 to 2.

(YₙSiX)₄₋ₙ Formula 1

### CROSS-REFERENCE TO RELATED APPLICATIONS

This application is a continuation application of International Application No. PCT/JP2017/042674, filed Nov. 28, 2017, the disclosure of which is incorporated herein by reference in its entirety. Further, this application claims priority from Japanese Patent Application No. 2016-233496, filed Nov. 30, 2016, the disclosure of which is incorporated herein by reference in its entirety.

### BACKGROUND OF THE INVENTION

### 1. Field of the Invention

The present disclosure relates to a coating composition, an antireflection film, a laminate, a method for manufacturing a laminate, and a solar cell module.

### 2. Description of the Related Art

In recent years, coating compositions that are intended to be applied to form thin layers that are several micrometers to several tens of nanometers in thickness using a variety of coating methods have been being broadly used in the uses of optical films, printing, and photolithography.

For example, in aqueous coating fluids, a solvent containing water as a main component is used, and thus formed films have a low surface energy and excellent transparency. In addition, coating fluids containing an organic solvent as a main component also have advantages of a low viscosity, a low surface tension, and the like, and thus both coating fluids are being used in a variety of uses.

As specific uses of these coating fluids, for example, antireflection films, optical lenses, optical filters, flattening films for thin film transistors (TFT) in a variety of displays, dew condensation prevention films, antifouling films, surface protection films, and the like are exemplified.

Among these, antireflection films can be applied to protective films in, for example, solar cell modules, surveillance cameras, lighting equipment, indicators, and the like and are thus useful.

For example, in solar cell modules, the reflection characteristics of glass disposed on an outermost layer on which the sunlight is incident (so-called front glass) have a significant influence on the power generation efficiency, and thus a variety of antireflection coating fluids for glass have been proposed from the viewpoint of improving the power generation efficiency.

As coating fluids that can be used for the uses of antireflection films and the like in solar cell modules, a variety of coating fluids capable of forming, for example, silica-based porous films in order to obtain a refractive index that is lower than those of glass base materials are proposed.

JP2010-503033A describes an optical coating composition including core-shell type nanoparticles, in which the nanoparticles include (a) a core material including a polymer and (b) a shell material including a metal oxide.

JP2010-509175A discloses a substrate (10, 10′, 10″, 100) at least partially coated with a porous coating (2, 2′) (at least the minimum characteristic dimension of this coating is at least 20 nm on average and does not exceed 100 nm) of at least one sol-gel-type essentially inorganic substance having a series of blocked micropores (20).

JP2006-335605A describes a method for producing a dispersion liquid of hollow SiO₂ fine particles in which hollow SiO₂ fine particles are dispersed in a dispersion medium, the method including steps (a) to (c) described below.
(a) A step of obtaining a dispersion liquid of fine particles by reacting a precursor of SiO₂ at a pH of higher than 8 in the presence of ZnO fine particles that configure a core in the dispersion medium to generate SiO₂ and coating the ZnO fine particles with the generated SiO₂,
(b) A step of dissolving the ZnO fine particles in the core in a pH range of 2 to 8 by mixing the dispersion liquid of fine particles obtained in (a) and an acidic cation-exchange resin and bringing them into contact with each other, and
(c) A step of obtaining the dispersion liquid of hollow SiO₂ fine particles by separating the ion-exchange resin with a solid-liquid separation operation after the ZnO fine particles are completely dissolved.

As a method for producing an antireflection film, a variety of methods for producing antireflection films for which a silica-based porous film is used are proposed.

For example, JP2014-214063A describes a silica-based porous film having a plurality of holes in a matrix containing silica as a main component, in which a refractive index is in a range of 1.10 to 1.38, holes having a diameter of 20 nm or more are included as the holes, the number of holes that are opened on an outermost surface and have a diameter of 20 nm or more is 13 holes/10⁶ nm² or less, and a water contact angle of the outermost surface is 70° or more.

JP2016-184023A describes a coating film for solar cell cover glass including silica, in which holes are present, an average hole diameter of the holes is 5 to 200 nm, a porosity is 30% or more and less than 60%, and a static contact angle with respect to water at 25° C. is less than 25°.

### SUMMARY OF THE INVENTION

Here, for example, front glass of solar cell modules is disposed on the outermost surface of a module, and thus there is another demand for improvement in scratch resistance or an antifouling property in addition to an antireflection property. Additionally, from the viewpoint of quality improvement, there is another demand for a coating fluid that is so excellent in liquid aging stability that the performance or viscosity does not significantly change over time.

However, it is difficult to provide coating compositions from which films that are excellent in terms of all of an antireflection property, scratch resistance, and an antifouling property can be obtained and which have an excellent liquid aging stability or antireflection films that are excellent in terms of all of an antireflection property, scratch resistance, and an antifouling property.

The present invention has been made in consideration of the above-described circumstances.

An object that an embodiment of the present invention intends to achieve is to provide a coating composition from which films that are excellent in terms of all of an antireflection property, scratch resistance, and an antifouling property can be obtained and which has an excellent liquid aging stability.

In addition, an object that another embodiment of the present invention intends to achieve is to provide an antireflection film that is excellent in terms of all of an antireflection property, scratch resistance, and an antifouling property.

Furthermore, an object that still another embodiment of the present invention intends to achieve is to provide a laminate having the antireflection film, a method for manufacturing the laminate, and a solar cell module including the laminate.

As means for achieving the above-described objects, the following aspects are included.

<1> A coating composition comprising: nonionic polymer particles having a number-average primary particle diameter of 5 nm to 200 nm; and a hydrolysable silane compound represented by Formula 1.

(YₙSiX)₄₋ₙ Formula 1

In Formula 1, X represents a hydrolysable group or a halogen atom, Y represents a non-hydrolysable group, and n represents an integer of 0 to 2.

<2> The coating composition according to <1>, in which a content of the hydrolysable silane compound in which n=1 is 90% by mass or more of a total mass of the hydrolysable silane compound.

<3> The coating composition according to <1> or <2>, in which a proportion of a total mass of the nonionic polymer particles to a total mass of the hydrolysable silane compound is 0.10 or more and 1.00 or less.

<4> The coating composition according to any one of <1> to <3>, further comprising: inorganic particles having a number-average primary particle diameter of 3 nm to 100 nm.

<5> The coating composition according to <4>, in which the inorganic particles are silica particles.

<6> The coating composition according to <4> or <5>, in which a proportion of a total mass of the inorganic particles to a total mass of the hydrolysable silane compound is 0.03 or more and 1.00 or less.

<7> The coating composition according to any one of <1> to <6>, in which a content of an organic solvent is 20% by mass or more of a total mass of the coating composition.

<8> An antireflection film which is a cured substance of the coating composition according to any one of <1> to <7>.

<9> The antireflection film according to <8>, in which an average film thickness is 80 nm to 200 nm.

<10> A laminate comprising: a base material; and the antireflection film according to <8> or <9>.

<11> The laminate according to <10>, in which the base material is a glass base material.

<12> A solar cell module comprising: the laminate according to <10> or <11>.

<13> A method for manufacturing a laminate comprising: a step of forming a coating film by applying the coating composition according to any one of <1> to <7> onto a base material; and a step of firing the coating film.

According to an embodiment of the present invention, a coating composition from which films that are excellent in terms of all of an antireflection property, scratch resistance, and an antifouling property can be obtained and which has an excellent liquid aging stability is provided.

In addition, according to another embodiment of the present invention, an antireflection film that is excellent in terms of all of an antireflection property, scratch resistance, and an antifouling property is provided.

Furthermore, according to still another embodiment of the present invention, a laminate having the antireflection film, a method for manufacturing the laminate, and a solar cell module including the laminate are provided.

### DESCRIPTION OF THE PREFERRED EMBODIMENTS

Hereinafter, the present disclosure will be described in detail.

In the present specification, numerical ranges expressed using “to” include numerical values before and after “to” as the lower limit value and the upper limit value respectively.

In addition, in the present specification, an amount of individual components in a composition refers to, in a case where there is a plurality of substances that correspond to the individual components in the composition, unless particularly otherwise described, a total amount of the plurality of substances that is present in the composition.

In the present specification, “(meth)acrylic” refers to any one of both acrylic and methacrylic, and “(meth)acrylate” refers to any one or both of acrylate and methacrylate.

In the present specification, a combination of two or more preferred aspects is a more preferred aspect.

In the present specification, regarding the expression of a group in a compound represented by a formula, an expression of a group that is not described as substituted or unsubstituted refers to, in a case where the group is capable of further having a substituent, unless particularly otherwise described, not only an unsubstituted group but also a group having a substituent. For example, in a case where there is an expression “R represents an alkyl group, an aryl group, or a heterocyclic group” in a formula, this means that “R represents an unsubstituted alkyl group, a substituted alkyl group, an unsubstituted aryl group, a substituted aryl group, an unsubstituted heterocyclic group, or a substituted heterocyclic group”.

In the present specification, a term “step” refers to not only an independent step but also a step that cannot be clearly differentiated from other steps as long as a predetermined object of the step is achieved.

<Coating Composition>

A coating composition according to an embodiment of the present disclosure includes nonionic polymer particles having a number-average primary particle diameter of 5 nm to 200 nm and a hydrolysable silane compound represented by Formula 1.

(YₙSiX)₄₋ₙ Formula 1

In Formula 1, X represents a hydrolysable group or a halogen atom, Y represents a non-hydrolysable group, and n represents an integer of 0 to 2.

Hitherto, techniques for forming an antireflection film on a glass base material using a coating fluid including a composition for forming a silica-based porous film have been known, but techniques for producing films that are excellent in terms of scratch resistance and an antifouling property while maintaining an antireflection property favorable have not yet been established.

In general, in order to obtain an excellent antireflection property, it is necessary to decrease the refractive index of a film.

In the case of decreasing the refractive index of a film using a silica-based porous film, it is necessary to increase the amount of pores per volume in the film (increase the porosity), but the present inventors found that, in many cases, an increase in the porosity leads to the deterioration of scratch resistance due to a decrease in the mechanical strength of the film or the adsorption of a foreign substance due to the formation of protrusions and recesses on a surface of the film (an increase in the surface area), that is, the deterioration of an antifouling property.

Therefore, the present inventors carried out intensive studies and consequently found that, according to a coating composition including nonionic polymer particles having a number-average primary particle diameter of 5 nm to 200 nm and a hydrolysable silane compound represented by Formula 1, films that are excellent in terms of an antireflection property, scratch resistance, and an antifouling property can be obtained, and liquid aging stability is excellent.

A reason for obtaining the above-described effects is not clear, but is assumed as described below.

For example, in the case of forming a coating film using the coating composition according to the embodiment of the present disclosure and then removing the nonionic polymer particles with a thermal treatment or the like, holes are formed in the film, and a film having an excellent antireflection property is formed.

Here, the coating composition according to the embodiment of the present disclosure includes the nonionic polymer particles, and thus it is considered that the polymer particles are more uniformly dispersed in the hydrolysable silane compound represented by Formula 1 that is a silica matrix precursor compared with the case of coating compositions including cationic or anionic polymer particles. In the present disclosure, the silica matrix refers to a phase that is obtained by the contraction of the hydrolysable silane compound represented by Formula 1 or the like that has been hydrolyzed. Therefore, it is assumed that, in the coating film, the nonionic polymer particles and the hydrolysable silane compound represented by Formula 1 are uniformly distributed, and consequently, the distribution of holes in the film that is formed by the removal (volatilization or the like by heating) of the nonionic polymer particles becomes uniform.

In addition, it is considered that, the number-average primary particle diameter of the nonionic polymer is 5 nm to 200 nm, whereby holes to be obtained become appropriate in size, and films that are excellent in terms of an antireflection property, scratch resistance, and an antifouling property are obtained.

In addition, it is considered that the distribution of holes becomes uniform due to the above-described mechanism, whereby the local deterioration of the mechanical strength due to a local increase in the density of holes or the local generation of a capillary force or cracks attributed to the uneven distribution of holes is suppressed, and the scratch resistance of a film to be obtained improves.

In addition, it is considered that the distribution of holes becomes uniform, whereby the generation of protrusion and recesses on the surface of the film or the generation of cracks in association with the capillary force is suppressed, and the antifouling property improves.

Furthermore, the coating composition includes the nonionic polymer particles, whereby the liquid aging stability of the coating composition also improves. A reason therefor is not clear, but is considered that the condensation of the hydrolysable silane compound represented by Formula 1 in the coating composition is suppressed, and the liquid aging stability improves.

Hereinafter, the respective components that are included in the coating composition will be described in detail.

(Nonionic Polymer Particles Having Number-Average Primary Particle Diameter of 5 nm to 200 nm)

The coating composition according to the embodiment of the present disclosure includes nonionic polymer particles having a number-average primary particle diameter of 5 nm to 200 nm (hereinafter, also referred to as “specific nonionic polymer particles”).

In the present disclosure, “nonionic polymer particles” refers to a polymer that is synthesized by emulsification polymerization for which a nonionic emulsifier is used and contains a structure derived from the nonionic emulsifier in the structure.

Here, nonionic polymer particles refer to polymer particles that contain the structure derived from the nonionic emulsifier in the structure and substantially do not contain any structures derived from anionic emulsifiers or any structures derived from cationic emulsifiers.

The expression “substantially do not contain any structure” indicates that the proportion of the structure derived from the nonionic emulsifier is 99% by mass or more in the total amount of structures derived from emulsifiers.

The proportion of the structure derived from the nonionic emulsifier can be computed by analyzing the fragments of the polymer particles through pyrolysis gas chromatography-mass spectrometry (GC-MS) and a well-known method.

The specific nonionic polymer particles that are used in the present disclosure are preferably self-dispersive particles. Self-dispersive particles refer to particles of a polymer that is insoluble in water and alcohols which can be in a state of being dispersed in an aqueous medium including water and an alcohol due to the intrinsic hydrophilic portions of the polymer particles. Meanwhile, the state of being dispersed refers to both states of an emulsified state (emulsion) in which the water and the alcohol-insoluble polymer are dispersed in an aqueous medium in a liquid state and a dispersed state (suspension) in which the water-insoluble polymer is dispersed in an aqueous medium in a solid state.

In addition, the expression “water-insoluble” indicates that the amount of the polymer dissolved in water (100 parts by mass) at 25° C. is 5.0 parts by mass or less.

The specific nonionic polymer particles that are used in the present disclosure are self-dispersive particles, whereby the specific nonionic polymer particles are likely to be uniformly dispersed in a film to be obtained, and, for example, the coating composition does not include any emulsifiers or it is possible to set the content of the emulsifier to 1% by mass or less of the total mass of the coating composition, and thus the scratch resistance and the antifouling property are excellent.

As the nonionic emulsifier for synthesizing the specific nonionic polymer particles of the present disclosure, a variety of nonionic emulsifiers can be preferably used, but nonionic emulsifiers having an ethylene oxide chain are preferably exemplified, and nonionic reactive emulsifiers having an ethylene oxide chain, which have a radical polymerizable double bond in a molecule, are more preferably exemplified. Due to the nonionic emulsifier, it is possible to obtain a favorable pencil hardness. A reason therefor is not clear, but is considered that emulsification stability during polymerization becomes favorable, whereby the dispersion state of the polymer particles in the film becomes uniform, and the distribution of holes becomes uniform, whereby the local generation of a capillary force and cracks attributed to the uneven distribution of holes is suppressed, and the scratch resistance of a film to be obtained improves.

As the nonionic emulsifier having an ethylene oxide chain, specifically, emulsifiers having a polyxoyethylene alkyl ether, a polyoxyethylene alkyl allyl ether, a polyoxyethyleneoxy propylene blocked copolymer, a polyethylene glycol aliphatic acid ester, a polyoxyethylene sorbitan aliphatic acid ester, or the like are exemplified.

As the reactive emulsifier, specifically, polyethylene glycol mono(meth)acrylate, polyoxyethylene alkyl phenol ether (meth)acrylate, monomaleic acid esters of polyoxyethylene glycol, derivatives thereof, 2,3-dihydroxypropyl methacrylate, 2-hydroxyethyl acrylamide, and the like, which have a variety of molecular weights (different numbers of moles of ethylene oxide added), are exemplified, and reactive emulsifiers having an ethylene oxide chain are preferred.

As the reactive emulsifier having an ethylene oxide chain, any emulsifiers can be used as long as an ethylene oxide chain is present and the number of closed chains is one or more; however, among them, preferred are emulsifiers in which the number of closed chains in the ethylene oxide chain is 2 or more and 30 or less and particularly preferably 3 or more and 15 or less. As the nonionic emulsifier having an ethylene oxide chain, at least one selected from the group of these can be used.

As the nonionic emulsifier, a commercially available product may also be used.

Examples of the commercially available product of the nonionic emulsifier include “NOIGEN” series, “AQUARON” series (all manufactured by DSK Co., Ltd.), “LATEMUL PD-420”, “LATEMUL PD-430”, “LATEMUL PD-450”, and “EMULGEN” series (all manufactured by KAO Corporation).

Among these, reactive emulsifiers having an ethylene oxide chain and having a radical polymerizable double bond in a molecule such as “AQUARON” series, “LATEMUL PD-420”, “LATEMUL PD-430”, and “LATEMUL PD-450” are most preferably used.

In addition, in the coating composition according to the embodiment of the present disclosure, ionic polymer particles are preferably not used as the polymer particles, but it is also possible to jointly use ionic polymer particles. In the case of mixing ionic polymer particles, the amount of the ionic polymer particles mixed is generally 30 parts by mass or less, preferably 10 parts by mass or less, and most preferably 3 parts by mass or less with respect to 100 parts by mass of the total amount of the polymer particles.

The specific nonionic polymer particles are particles that can be removed from coating films formed of the coating composition and preferably particles that can be removed from the coating films by a thermal treatment.

As the particles that can be removed from the coating films by a thermal treatment, for example, particles that are removed by at least one of decomposition or volatilization at the time of carrying out the thermal treatment are exemplified.

The number-average primary particle diameter of the specific nonionic polymer particles is 5 nm to 200 nm.

In a case where the number-average primary particle diameter is set to 5 nm or more, coating compositions that are excellent in terms of the antireflection property of a film to be obtained are obtained. This is considered to be because holes attributed to the removal of the specific nonionic polymer particles are sufficiently obtained.

In addition, in a case where the number-average primary particle diameter is set to 200 nm or less, coating compositions that are excellent in terms of the scratch resistance of a film to be obtained are obtained. This is considered to be because it is possible to prevent the formation of excess holes in the film to be obtained.

Furthermore, in a case where the number-average primary particle diameter is set to 200 nm or less, coating compositions that are excellent in terms of the antireflection property of a film to be obtained are obtained. This is considered to be because it is possible to uniform the film thickness distribution of the film to be obtained.

Additionally, in a case where the number-average primary particle diameter is set to 200 nm or less, coating compositions that are excellent in terms of the antifouling property of a film to be obtained are obtained. This is considered to be because it is possible to uniform the distribution of holes that are formed in the film and a film in which protrusions and recesses on the surface of the film are small is formed.

The number-average primary particle diameter of the specific nonionic polymer particles is preferably 120 nm or less from the viewpoint of further improving the antireflection property of a film to be obtained.

In addition, the number-average primary particle diameter of the specific nonionic polymer particles is preferably 10 nm or more, more preferably 20 nm or more, and still more preferably 30 nm or more from the viewpoint of further improving the antireflection property of a film to be obtained.

The number-average primary particle diameter of the specific nonionic polymer particles is measured using a dynamic light scattering method. Specifically, primary particle diameters are measured using Microtrac (Version 10.1.2-211BH) manufactured by Nikkiso Co., Ltd., and a value obtained as the cumulative 50% value (d50) of number-equivalent particle diameters is regarded as the number-average primary particle diameter of the specific nonionic polymer particles.

The pyrolysis temperature of the specific nonionic polymer particles is preferably 300° C. to 800° C. and more preferably 400° C. to 700° C.

Here, the pyrolysis temperature refers to a temperature when the mass reduction ratio reaches 50% by mass in thermogravimetric and thermal differential analysis (TG/TDA) measurement.

The glass transition temperature (Tg) of the specific nonionic polymer particles is preferably 0° C. to 150° C. and more preferably 30° C. to 100° C.

In a case where Tg is set to 150° C. or lower, the antifouling property of a film to be obtained further improves. This is considered to be because the fluidity of the coating composition is enhanced, whereby the distribution in the film of the hydrolysable silane compound represented by Formula 1 becomes uniform.

In a case where Tg is set to 0° C. or higher, the scratch resistance of a film to be obtained further improves. This is considered to be because it is possible to set the pyrolysis temperature of the specific nonionic polymer particles to 300° C. or higher and it is possible to obtain holes having a uniform size while maintaining the mechanical strength of the film at a high level.

The glass transition temperature is obtained from a DSC curve obtained by differential scanning calorimetry (DSC) and, more specifically, obtained from “extrapolated glass transition onset temperature” described in a method for obtaining glass transition temperatures of JIS K7121-1987 “Testing methods for transition temperatures of plastics”.

A polymer that is included in the specific nonionic polymer particles is not particularly limited as long as nonionic polymer particles having a desired particle diameter can be obtained, but is preferably a homopolymer or copolymer of a monomer selected from the group (hereinafter, also referred to as “specific monomer group”) consisting of (meth)acrylic acid ester-based monomers, styrene-based monomers, diene-based monomers, imide-based monomers, or amide-based monomers.

In addition, from the viewpoint of the liquid aging stability of the coating composition, the polymer that configures the specific nonionic polymer particles preferably does not include any functional group that is reacted with a silanol group and condensed such as a hydroxy group or a carboxy group.

As the (meth)acrylic acid ester-based monomers, methyl (meth)acrylate, ethyl (meth)acrylate, propyl (meth)acrylate, isopropyl (meth)acrylate, butyl (meth)acrylate, isobutyl (meth)acrylate, pentyl (meth)acrylate, hexyl (meth)acrylate, 2-ethylhexyl (meth)acrylate, octyl (meth)acrylate, lauryl (meth)acrylate, nonyl (meth)acrylate, decyl (meth)acrylate, dodecyl (meth)acrylate, phenyl (meth)acrylate, methoxyethyl (meth)acrylate, ethoxyethyl (meth)acrylate, propoxyethyl (meth)acrylate, butoxyethyl (meth)acrylate, ethoxypropyl (meth)acrylate, diethylaminoethyl (meth)acrylate, dialkylaminoalkyl (meth)acrylate, glycidyl (meth)acrylate, diacrylic acid esters of ethylene glycol, diacrylic acid esters of diethyl glycol, diacrylic acid esters of triethylene glycol, diacrylic acid esters of polyethylene glycol, diacrylic acid esters of dipropylene glycol, diacrylic acid esters of tripropylene glycol, dimethacrylic acid esters of ethylene glycol, dimethacrylic acid esters of diethylene glycol, dimethacrylic acid esters of triethylene glycol, diacrylic acid esters of polyethylene glycol, dimethacrylic acid esters of propylene glycol, dimethacrylic acid esters of dipropylene glycol, dimethacrylic acid esters of tripropylene glycol, and the like are exemplified.

As the styrene-based monomers, styrene, methylstyrene, dimethylstyrene, trimethylstyrene, ethylstyrene, diethylstyrene, triethylstyrene, propylstyrene, butylstyrene, hexylstyrene, heptylstyrene, octylstyrene, fluorostyrene, chlorostyrene, bromostyrene, dibromostyrene, chloromethylstyrene, nitrostyrene, acetylstyrene, methoxystyrene, α-methylstyrene, vinyl toluene, sodium p-styrene sulfonate, and the like are exemplified.

As the diene-based monomers, butadiene, isoprene, cyclopentadiene, 1,3-pentadiene, dicyclopentadiene, and the like are exemplified.

As the imide-based monomers, maleimide, N-methylmaleimide, N-phenylmaleimide, N-cyclohexylmaleimide, 6-aminohexyl succinimide, 2-aminoethyl succinimide, and the like are exemplified.

As the amide-based monomers, acrylamide-based derivatives such as acrylamide and N-methylacrylamide, allylamine-based derivatives such as N,N-dimethylacrylamide and N,N-dimethylaminopropylacrylamide, aminostyrenes such as N-aminostyrene, and the like are exemplified.

The polymer that the nonionic polymer particles contain is preferably a polymer having a crosslinking structure in order to obtain dispersibility in solvents.

Polymer particles having a crosslinking structure can be obtained by polymerizing an emulsifier described below and a crosslinking reactive monomer. Crosslinking reactive monomers that can be used are not particularly limited, examples thereof include crosslinking reactive monomers having an unsaturated double bond in a molecule, crosslinking reactive monomers having a radical polymerizable double bond, and crosslinking reactive monomers having a reactive functional group in a molecule (specifically, a carboxy group, a hydroxy group, an epoxy group, an amino group, an amide group, a maleimide group, a sulfonic acid group, a phosphoric acid group, an isocyanate group, an alkoxy group, an alkoxysilyl group, and the like are exemplified), and the crosslinking reactive monomer is selected from the above-described monomers or combinations thereof.

Among these, the crosslinking reactive monomer is preferably a monomer having a radical polymerizable double bond and more preferably a (meth)acrylic acid ester-based monomer or styrene-based monomer having a plurality of radical polymerizable double bonds in a molecule.

As such crosslinking reactive monomers, for example, polyfunctional (meth)acrylates such as trimethylolpropane triacrylate, ethylene glycol dimethacrylate, diethylene glycol dimethacrylate, triethylene glycol dimethacrylate, decaethylene glycol dimethacrylate, pentadecaethylene glycol dimethacrylate, pentacontahectaethylene glycol dimethacrylate, 1,3-butylene dimethacrylate, allyl methacrylate, trimethylolpropane trimethacrylate, and pentaerythritol tetraacrylate; aromatic divinyl compounds such as divinyl benzene, divinyl naphthalene, and derivatives thereof; N,N-divinyl aniline; divinyl ether; divinyl sulfide; divinyl sulfonate; polybutadiene; polyisoprene unsaturated polyester; and the like.

The proportion of the total mass of the specific nonionic polymer particles to the total mass of a specific hydrolysable silane compound described below is preferably 0.10 or more and 1.00 or less, more preferably 0.10 or more and 0.50 or less, and still more preferably 0.10 or more and 0.30 or less from the viewpoint of the antireflection property, the scratch resistance, and the antifouling property of a film to be obtained.

The proportion of the total mass of the specific nonionic polymer particles to the total mass of the specific hydrolysable silane compound refers to a value obtained from (the total mass of the specific nonionic polymer particles)/(the total mass of the specific hydrolysable silane compound).

In a case where the proportion of the total mass of the specific nonionic polymer particles to the total mass of the specific hydrolysable silane compound is 0.10 or more, the antireflection property of a film to be obtained further improves. This is considered to be because sufficient holes can be obtained in the film.

In addition, in a case where the proportion of the total mass of the specific nonionic polymer particles to the total mass of the specific hydrolysable silane compound is 1.00 or less, the scratch resistance of a film to be obtained further improves. This is considered to be because the formation of excess holes in the film is prevented.

Furthermore, in a case where the proportion of the total mass of the specific nonionic polymer particles to the total mass of the specific hydrolysable silane compound is 1.00 or less, the antifouling property of a film to be obtained further improves. This is considered to be because the size distribution of holes being formed in the film becomes uniform, whereby films in which protrusions and recesses on the surface of the film are small can be obtained.

(Hydrolysable Silane Compound Represented by Formula 1)

The coating composition according to the embodiment of the present disclosure contains a hydrolysable silane compound represented by Formula 1 (hereinafter, also referred to as “specific hydrolysable silane compound”).

(YₙSiX)₄₋ₙ Formula 1

In the formula, X represents a hydrolysable group or a halogen atom, Y represents a non-hydrolysable group, and n represents an integer of 0 to 2.

The hydrolysable group represented by X is not particularly limited as long as a Si—X bond turns into a Si—OH bond through a hydrolysis in the hydrolysable group, may be a halogen atom or a well-known hydrolysable group in the field of a hydrolysable silane compound, but is preferably an alkoxy group having 1 to 20 carbon atoms or a halogen atom and more preferably an alkoxy group having 1 to 20 carbon atoms.

In a case where there is a plurality of X's, the plurality of X's may be identical to or different from each other.

The non-hydrolysable group represented by Y is not particularly limited as long as the group is not hydrolyzed under a condition in which the Si—X bond turns into a Si—OH bond through a hydrolysis in the hydrolysable group, may be a well-known non-hydrolysable group in the field of a hydrolysable silane compound, but is preferably an alkyl group, a cycloalkyl group, an aryl group, a vinyl group, or an allyl group, and more preferably an alkyl group having 1 to 20 carbon atoms, a cycloalkyl group having 5 to 20 carbon atoms, or an aryl group having 6 to 20 carbon atoms.

The alkyl group may have a linear form or a branched form and may include a ring structure in the structure.

The alkyl group may be substituted, and, as a preferred substituent, a halogen atom, an amino group, a mercapto group, a hydroxy group, an isocyanate group, a glycidoxy group, an alicyclic epoxy group, a (meth)acryloxy group, an ureido group, and the like are exemplified.

The cycloalkyl group may be substituted, and, as a preferred substituent, an alkyl group having 1 to 20 carbon atoms is exemplified in addition to the groups exemplified as the substituent in the alkyl group.

The aryl group may be substituted, and, as a preferred substituent, an alkyl group having 1 to 20 carbon atoms and an alkoxy group having 1 to 20 carbon atoms are exemplified in addition to the groups exemplified as the substituent in the alkyl group.

In a case where there is a plurality of Y's, the plurality of Y's may be identical to or different from each other.

n is an integer of 0 to 2, preferably an integer of 1 or 2, and more preferably 1.

In addition, the specific hydrolysable silane compound may be used singly or a plurality of specific hydrolysable silane compounds may be jointly used. In a case where a plurality of specific hydrolysable silane compounds is jointly used, it is preferable to use at least one specific hydrolysable silane compound in which n=1.

n is not particularly limited, but the content of the specific hydrolysable silane compound in which n=1 (the total content in a case where a plurality of the specific hydrolysable silane compounds in which n=1 is included) is preferably 90% by mass or more, more preferably 95% by mass or more, still more preferably 98% by mass or more, and particularly preferably 100% by mass of the total mass of the specific hydrolysable silane compounds.

In a case where the content of the specific hydrolysable silane compound in which n=1 is in the above-described range, the scratch resistance of a film to be obtained further improves, and the liquid aging stability further improves. This is considered to be because, due to the favorable hydrolysability, the hardness of the film improves and the film has an appropriate reactivity, whereby the reaction in liquid is suppressed.

In addition, in a case where the content of the specific hydrolysable silane compound in which n=1 is in the above-described range, the antifouling property of a film to be obtained further improves. This is considered to be because a film in which protrusions and recesses on the surface of the film are small is formed.

The joint use of a plurality of the specific hydrolysable silane compounds enables the adjustment of the scratch resistance and the antifouling property of a film to be obtained and the liquid aging stability of the coating composition.

The specific hydrolysable silane compound is not particularly limited, and examples thereof include tetraalkoxysilanes such as tetramethoxysilane, tetraethoxysilane, tetra-n-propoxysilane, tetraisopropoxysilane, and tetra-n-butoxysilane;
trialkoxysilanes such as methyltrimethoxysilane, methyltriethoxysilane, ethyltrimethoxysilane, ethyltriethoxysilane, n-propyltrimethoxysilane, n-propyltriethoxysilane, isopropyltrimethoxysilane, isopropyltriethoxysilane, n-butyltrimethoxysilane, n-butyltriethoxysilane, n-pentyltrimethoxysilane, n-hexyltrimethoxysilane, n-hexyltriethoxysilane, n-heptyltrimethoxysilane, n-octyltrimethoxysilane, vinyltrimethoxysilane, vinyltriethoxysilane, allyltrimethoxysilane, cyclohexyltrimethoxysilane, cyclohexyltriethoxysilane, phenyltrimethoxysilane, phenyltriethoxysilane, 3-chloropropyltrimethoxysilane, 3-chloropropylpropyltriethoxysilane, 3,3,3-trichloropropyl trimethoxysilane, 3,3,3-trifluoropropyl triethoxysilane, 3-aminopropyl trimethoxysilane, 3-aminopropyl triethoxysilane, 2-hydroxyethyl trimethoxysilane, 2-hydroxyethyl triethoxysilane, 2-hydroxypropyltrimethoxysilane, 2-hydroxypropyltriethoxysilane, 3-hydroxypropyltrimethoxysilane, 3-hydroxypropyltriethoxysilane, 3-mercaptopropyltrimethoxysilane, 3-mercaptopropropyltriethoxysilane, 3-isocyanatopropyltrimethoxysilane, 3-isocyanatopropyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 3-(meth)acryloxypropyltrimethoxysilane, 3-(meth)acryloyloxypropyltriethoxysilane, 3-(meth)acryloyloxypropyl tri-n-propoxysilane, 3-(meth)acryloyloxypropyltriisopropoxysilane, 3-ureidopropyltrimethoxysilane, and 3-ureidopropyltriethoxysilane; and
dialkoxysilanes such as dimethyldimethoxysilane, dimethyldiethoxysilane, diethyldimethoxysilane, diethyldiethoxysilane, di-n-propyldimethoxysilane, diethyldimethoxysilane, diethyldiethoxysilane, di-n-propyldimethoxysilane, di-n-propyldiethoxysilane, diisopropyldimethoxysilane, diisopropyldiethoxysilane, di-n-butyldimethoxysilane, di-n-butyldiethoxysilane, di-n-pentyldimethoxysilane, di-n-pentyldiethoxysilane, di-n-hexyldimethoxysilane, di-n-hexyldiethoxysilane, di-n-heptyldimethoxysilane, di-n-heptyldiethoxysilane, di-n-octyldimethoxysilane, di-n-octyldiethoxysilane, di-n-cyclohexyldimethoxysilane, di-n-cyclohexyldiethoxysilane, diphenyldimethoxysilane, diphenyldiethoxysilane, and 3-(meth)acryloyloxypropylmethyldimethoxysilane.

Among these, specific hydrolysable silane compounds in which n=1 are preferred, specific hydrolysable silane compounds in which n=1 and the non-hydrolysable group represented by Y is a linear or branched alkyl group having 1 to 20 carbon atoms are more preferred, and, specifically, methyl trimethoxysilane, methyltriethoxysilane, ethyltrimethoxysilane, ethyltriethoxysilane, n-propyltrimethoxysilane, n-propyltriethoxysilane, isopropyltrimethoxysilane, isopropyltriethoxysilane, n-butyltrimethoxysilane, n-butyltriethoxysilane, n-pentyltrimethoxysilane, n-hexyltrimethoxysilane, n-heptyltrimethoxysilane, and n-octyltrimethoxysilane are exemplified.

As the specific hydrolysable silane compound, commercially available products may be used. Examples of the commercially available products include tetramethoxysilane (KBM-04), methyltrimethoxysilane (KBM-13), dimethyldimethoxysilane (KBM-22), phenyltrimethoxysilane (KBM-103), tetraethoxysilane (KBE-04), diphenyldimethoxysilane (KBM-202SS), methyltriethoxysilane (KBE-13), dimethyldiethoxysilane (KBE-22), phenyltriethoxysilane (KEB-103), diphenyldiethoxysilane (KBE-202), n-hexyltrimethoxysilane (KBM-3063), n-hexyltriethoxysilane (KBE-3063), n-propyltriethoxysilane (KBE-3033), decyltrimethoxylsilane (KBM-3103), decyltrimethoxysilane (KBM-3103C), and trifluoropropyltrimethoxysilane (KBM-7103) which are manufactured by Shin-Etsu Chemical Co., Ltd.

The content of the specific hydrolysable silane compound is preferably 0.3% by mass to 20% by mass, more preferably 0.5% by mass to 10% by mass, and still more preferably 1% by mass to 6% by mass of the total mass of the coating composition.

(Inorganic Particles Having Number-Average Primary Particle Diameter of 3 nm to 100 nm)

The coating composition preferably contains inorganic particles having a number-average primary particle diameter of 3 nm to 100 nm (hereinafter, also referred to as “specific inorganic particles”). In a case where the coating composition contains inorganic particles having a number-average primary particle diameter of 3 nm to 100 nm, it is possible to improve the scratch resistance and the antifouling property of a film to be obtained while maintaining a favorable antireflection characteristic.

The specific inorganic particles are particles including at least one of boron, phosphorus, silicon, aluminum, titanium, zirconium, zinc, tin, indium, gallium, germanium, antimony, molybdenum, cerium, or the like and preferably particles of an oxide including at least one element of the above-described elements. As such oxide particles, particles of silicon oxide (silica), titanium oxide, aluminum oxide (alumina), zinc oxide, germanium oxide, indium oxide, tin oxide, antimony oxide, cerium oxide, zirconium oxide, and the like are exemplified. As the specific inorganic particles, metal oxides other than those exemplified herein may also be included.

From the viewpoint of further improving the antireflection property and the scratch resistance of the film, as the specific inorganic particles, silica or alumina particles are preferably used, and silica particles are more preferably used. As the silica particles, for example, hollow silica particles porous silica particles, non-porous silica particles, and the like are exemplified. The shape of the silica particle is not particularly limited and may be, for example, any shape of a spherical shape, an elliptical shape, a chain shape, and the like.

In addition, the silica particles may be silica particles having a surface treated with an aluminum compound or the like.

The coating composition may include two or more types of specific inorganic particles. In the case of including two or more types of specific inorganic particles, the coating composition may include two or more types of specific inorganic particles that are different in at least any one of the shape, the particle diameter, or the element composition.

The number-average primary particle diameter of the specific inorganic particles is 3 nm to 100 nm, and, in a case where the particle diameter is set to 3 nm or more, it is possible to obtain a sufficient scratch resistance improvement effect of the addition of the specific inorganic particles. In addition, in a case where the particle diameter is set to 100 nm or less, it is possible to maintain the porosity of the film at an appropriate value in spite of the addition of the specific inorganic particles, and an excellent antireflection performance can be obtained.

The number-average primary particle diameter of the specific inorganic particles is preferably 80 nm or less, more preferably 30 nm or less, and particularly preferably 15 nm or less.

The number-average primary particle diameter of the specific inorganic particles can be obtained from an image of a photograph captured by observing the dispersed silica specific inorganic particles using a transmission electron microscope. Specifically, for 200 particles randomly extracted from the image of the photograph, the projected areas of the specific inorganic particles are measured, circle-equivalent diameters are obtained from the measured projected areas, and a value obtained by arithmetically averaging the values of the obtained circle-equivalent diameters is regarded as the number-average primary particle diameter of the specific inorganic particles.

The silica particles that are preferably included in the coating composition are preferably non-porous silica particles.

“Non-porous silica particles” refer to silica particles having no pores in the particles and are differentiated from silica particles having pores in the particles such as hollow silica particles and porous silica particles. Meanwhile, silica particles having a core-shell structure in which the core such as a polymer is present in the particles and the shell of the core is configured of silica or a precursor of silica (a material that changes to silica by, for example, firing) are not regarded as the “non-porous silica particles”.

In the case of firing the coating film, the state of the non-porous silica particles being present in the coating film are considered to change before and after the firing. Specifically, it is considered that, in the coating film before firing, the respective non-porous silica particles are present as a single particle (here, a state in which particles are gathered together such as a state in which particles are agglomerated by Van der Walls forces is regarded as a single particle), and, in the coating film after firing, at least some of a plurality of non-porous silica particles are present as particle-connected bodies in which the particles are connected to each other.

In a case where the silica particles that are included in the coating composition are non-porous silica particles, the scratch resistance further improves. This is considered to be because, due to the firing of the coating film, a plurality of non-porous silica particles is connected to each other, and particle-connected bodies are formed, and thus the hardness of the film increases.

As the silica particles that are preferably used, commercially available products may also be used. Examples of the commercially available products include NALCO (registered trademark) 8699 (water dispersion of non-porous silica particles, number-average primary particle diameter: 3 nm, solid content: 15% by mass, manufactured by Katayama Nalco Inc.), NALCO (registered trademark) 1130 (water dispersion of non-porous silica particles, number-average primary particle diameter: 8 nm, solid content: 30% by mass, manufactured by Katayama Nalco Inc.), NALCO (registered trademark) 1030 (water dispersion of non-porous silica particles, number-average primary particle diameter: 13 nm, solid content: 30% by mass, manufactured by Katayama Nalco Inc.), NALCO (registered trademark) 1050 (water dispersion of non-porous silica particles, number-average primary particle diameter: 20 nm, solid content: 50% by mass, manufactured by Katayama Nalco Inc.), NALCO (registered trademark) 1060 (water dispersion of non-porous silica particles, number-average primary particle diameter: 60 nm, solid content: 50% by mass, manufactured by Katayama Nalco Inc.), SNOWTEX (registered trademark) ST-OXS (water dispersion of non-porous silica particles, number-average primary particle diameter: 4 nm to 6 nm, solid content: 10% by mass, manufactured by Nissan Chemical Corporation), SNOWTEX (registered trademark) ST-O (water dispersion of non-porous silica particles, number-average primary particle diameter: 10 nm to 15 nm, solid content: 20% by mass, manufactured by Nissan Chemical Corporation), SNOWTEX (registered trademark) ST-O-40 (water dispersion of non-porous silica particles, number-average primary particle diameter: 20 nm to 25 nm, solid content: 40% by mass, manufactured by Nissan Chemical Corporation), SNOWTEX (registered trademark) ST-OYL (water dispersion of non-porous silica particles, number-average primary particle diameter: 50 nm to 80 nm, solid content: 20% by mass, manufactured by Nissan Chemical Corporation), SNOWTEX (registered trademark) ST-OUP (water dispersion of non-porous silica particles, number-average primary particle diameter: 40 nm to 100 nm, solid content: 15% by mass, manufactured by Nissan Chemical Corporation), and the like.

The proportion of the total mass of the specific inorganic particles to the total mass of the specific hydrolysable silane compound is preferably 0.03 or more and 1.00 or less, more preferably 0.03 or more and 0.50 or less, and still more preferably 0.03 or more and 0.20 or less from the viewpoint of the scratch resistance and the antifouling property of a film to be obtained.

The proportion of the total mass of the specific inorganic particles to the total mass of the specific hydrolysable silane compound refers to a value obtained from (the total mass of the specific inorganic particles)/(the total mass of the specific hydrolysable silane compound).

In a case where the proportion is 0.03 or more, it is easy to obtain films that are excellent in terms of scratch resistance. In a case where the proportion of the total mass of the specific inorganic particles to the total mass of the specific hydrolysable silane compound is 1.00 or less, the antifouling property of a film to be obtained is superior. This is considered to be because films in which protrusions and recesses on the surface are small are likely to be formed.

(Solvent)

The coating composition according to the embodiment of the present disclosure preferably includes a solvent.

The solvent is preferably a solvent that disperses the nonionic polymer particles having a number-average primary particle diameter of 5 nm to 200 nm and dissolves the hydrolysable silane compound represented by Formula 1.

In addition, the solvent may be a solvent made of a single liquid or may be a mixture of two or more liquids.

The content of the solvent is preferably 90% by mass to 99% by mass, more preferably 92% by mass to 98% by mass, and still more preferably 94% by mass to 98% by mass of the total mass of the coating composition.

The solvent preferably includes at least water. From the viewpoint of further improving the scratch resistance of a film to be obtained, the content of water in the coating composition is preferably 5% by mass to 70% by mass, more preferably 5% by mass to 50% by mass, and still more preferably 5% by mass to 30% by mass of the total mass of the coating composition.

In a case where the content of water is in the above-described range, it is considered that the silica matrix can be efficiently obtained due to the hydrolysis of the hydrolysable silane compound represented by Formula 1.

Water that is used in the coating composition is preferably water including no impurities or having a decreased content of impurities. For example, deionized water is preferably exemplified.

The coating composition preferably contains an organic solvent. The organic solvent is not particularly limited as long as the solvent disperses the nonionic polymer particles having a number-average primary particle diameter of 5 nm to 200 nm and dissolves the hydrolysable silane compound represented by Formula 1, and it is possible to use, for example, an alcohol-based solvent, an ester-based solvent, a ketone-based solvent, an ether-based solvent, an amide-based solvent, or the like.

Examples of the alcohol-based solvent include alcohols (monovalent alcohols) such as methanol, ethanol, 1-propanol, isopropanol, 1-butanol, 2-butanol, 3-methyl-1-butanol, tert-butyl alcohol, 1-pentanol, 2-pentanol, 1-hexanol, 2-hexanol, 3-hexanol, 3-methyl-3-pentanol, cyclopentanol, 2,3-dimethyl-2-butanol, 3,3-dimethyl-2-butanol, 2-methyl-2-pentanol, 2-methyl-3-pentanol, 3-methyl-2-pentanol, 3-methyl-3-pentanol, 4-methyl-2-pentanol, 4-methyl-3-pentanol, cyclohexanol, 5-methyl-2-hexanol, and 4-methyl-2-hexanol, glycol-based solvents such as ethylene glycol, diethylene glycol, and triethylene glycol, glycol ether-based solvents containing a hydroxyl group such as ethylene glycol monomethyl ether, propylene glycol monomethyl ether, diethylene glycol monomethyl ether, triethylene glycol monoethyl ether, methoxymethylbutanol, ethylene glycol monoethyl ether, ethylene glycol monopropyl ether, ethylene glycol monobutyl ether, and propylene glycol monoethyl ether, and the like.

Examples of the ester-based solvent include methyl acetate, ethyl acetate, butyl acetate, isobutyl acetate, pentyl acetate, propyl acetate, isopropyl acetate, amyl acetate (pentyl acetate), isoamyl acetate (isopentyl acetate, 3-methyl butyl acetate), 2-methylbutyl acetate, 1-methylbutyl acetate, hexyl acetate, isohexyl acetate, propylene glycol monomethyl ether acetate, methyl formate, ethyl formate, butyl formate, propyl formate, ethyl lactate, butyl lactate, propyl lactate, ethyl lactate, propyl lactate, butyl carbonate, methyl pyruvate, ethyl pyruvate, propyl pyruvate, butyl pyruvate, methyl acetoacetate, ethyl acetoacetate, methyl propionate, and the like.

Examples of the ketone-based solvent include acetone, 1-hexanone, 2-hexanone, diethyl ketone, cyclohexanone, methylcyclohexanone, phenylacetone, methyl ethyl ketone, methyl isobutyl ketone, acetyl acetone, acetonyl acetone, ionone, propylene carbonate, γ-butyrolactone, and the like.

Examples of the ether-based solvent include, in addition to the above-described glycol ether-based solvents containing a hydroxyl group, glycol ether-based solvents containing no hydroxyl group such as propylene glycol dimethyl ether, aromatic ether solvents such as anisole, dioxane, tetrahydrofuran, and 1,4-dioxane, isopropyl ether.

As the amide-based solvent, it is possible to use, for example, N-methyl-2-pyrrolidone, N,N-dimethylacetamide, N,N-dimethylformamide, and the like.

Among these, from the viewpoint of the dispersibility of the specific nonionic polymer particles, the alcohol-based solvents are preferred, monovalent alcohols are more preferably used, and ethanol or isopropanol is still more preferably used.

From the viewpoint of the antireflection property, the scratch resistance, and the antifouling property of a film to be obtained and the liquid aging stability of the coating composition, the content of the organic solvent in the coating composition is preferably 20% by mass or more, more preferably 20% by mass to 95% by mass, still more preferably 30% by mass to 95% by mass, and particularly preferably 50% by mass to 95% by mass of the total mass of the coating composition.

In a case where the content of the organic solvent is 20% by mass or more, the antireflection property of a film to be obtained is excellent. This is considered to be because it is easy to obtain coating films that are excellent in terms of the surface state.

In addition, in a case where the content of the organic solvent is set to 20% by mass or more, it is possible to improve the wettability to the specific nonionic polymer particles, and it is considered that such a content is advantageous in terms of the improvement of the dispersibility of the specific nonionic polymer particles in the coating composition. As a result, it is considered that particle settlement by agglomeration can be suppressed and the aging stability of the coating composition improves. In addition, the distribution of holes that are formed by the removal of the specific nonionic polymer particles becomes uniform, the local deterioration of the mechanical strength or the local generation of a capillary force or cracks can be suppressed, and it is possible to improve the scratch resistance and the antifouling property.

In a case where the content of the organic solvent is 95% by mass or less, coating compositions that are superior in terms of coatability and facilitate the formation of films can be obtained.

(Other Components)

The coating composition may also include other components such as a monofunctional hydrolysable silane compound represented by Formula 2, an alkali metal silicate, a surfactant, or a thickener as necessary.

[Monofunctional Hydrolysable Silane Compound Represented by Formula 2]

The coating composition according to the embodiment of the present disclosure may further contain a monofunctional hydrolysable silane compound represented by Formula 2.

(Y₃Si—X Formula 2

In Formula 2, X represents a hydrolysable group or a halogen atom, and Y represents a non-hydrolysable group.

In Formula 2, X and Y are respectively identical to X and Y in Formula 1, and preferred ranges thereof are also identical thereto.

In a case where the coating composition according to the embodiment of the present disclosure includes the monofunctional hydrolysable silane compound represented by Formula 2, the content of the monofunctional hydrolysable silane compound represented by Formula 2 is preferably 1% by mass to 20% by mass, more preferably 2% by mass to 10%0/by mass, and still more preferably 3% by mass to 6% by mass of the total mass of the coating composition.

[Alkali Metal Silicate]

The coating composition may contain an alkali metal silicate. In a case where the coating composition contains an alkali metal silicate, both the antireflection property and the scratch resistance are improved, which makes the alkali metal silicate useful. The alkali metal silicate refers to an alkali metal salt of silicic acid, and an alkali metal silicate represented by Formula A is preferred.

M₂O.nSiO₂ Formula A

In Formula A, M represents an alkali metal.

As the alkali metal, lithium (Li), sodium (Na), potassium (K), cesium (Cs), and the like are exemplified.

The alkali metal represented by M is preferably Li or K.

In a case where Li or K is selected as the alkali metal, the alkali metal further improves the scratch resistance than Na.

In Formula A, n represents a molar ratio of the alkali metal silicate. From the viewpoint of the crosslinking property, a compound in which n is 5.0 or less is preferred.

In a case where the molar ratio n of the alkali metal silicate is an appropriate value, it is considered that it becomes easy for the alkali metal silicate to be crosslinked. Therefore, in a case where M is Li, it is considered that the selection of a compound in which n<5.0 is satisfied facilitates the crosslinking of the alkali metal silicate with silica particles and further improves the scratch resistance. In a case where the alkali metal represented by M is Li, n is more preferably 3.0 or more.

[Surfactant]

The coating composition may contain a surfactant. In a case where the coating composition contains a surfactant, it is effective to improve the wettability of the coating composition to a base material.

As the surfactant, for example, acetylene-based nonionic surfactants, polyol-based nonionic surfactants, and the like can be exemplified. In addition, as the surfactant, commercially available products on sale may also be used, and it is possible to use, for example, OLFINE series manufactured by Nissin Chemical Co., Ltd. (for example, OLFINE EXP. 4200, OLFINE EXP. 4123, and the like), TRITON BG-10 manufactured by The Dow Chemical Company, MYDOL series manufactured by KAO Corporation (for example, MYDOL 10, MYDOL 12, and the like), and the like.

[Thickener]

The coating composition may contain a thickener. In a case where the coating composition includes a thickener, it is possible to adjust the viscosity of the coating composition.

As the thickener, for example, polyether, urethane-modified polyether, polyacrylic acid, polyacrylic sulfonic acid salts, polyvinyl alcohols, polysaccharides, and the like are exemplified. Among these, polyether, modified polyacrylic sulfonic acid salts, and polyvinyl alcohols are preferred. As the thickener, commercially available products on sale may also be used, and examples of the commercially available products include SN THICKENER 601 (polyether) and SN THICKENER 615 (modified polyacrylic sulfonic acid salt) manufactured by San Nopco Limited, polyvinyl alcohols (degree of polymerization: approximately 1,000 to 2,000) manufactured by Wako Pure Chemical Industries, Ltd., and the like.

The content of the thickener is preferably approximately 0.01% by mass to 5.0% by mass of the total mass of the coating composition.

[Amount of Solid Contents]

The amount of solid contents of the coating composition is preferably 1% by mass to 30% by mass, more preferably 1% by mass to 20% by mass, and still more preferably 2% by mass to 10% by mass of the total mass of the coating composition. In a case where the amount of the solid contents of the coating composition is set in this range, it is possible to adjust the film thickness of an antireflection film to be in a range in which a favorable antireflection characteristic can be obtained. The amount of the solid contents of the coating composition can be adjusted using the contents of the solvent and water.

Meanwhile, the amount of the solid contents of the coating composition refers to the proportion of the mass of the coating composition excluding the solvent in the total mass of the coating composition.

[pH]

The pH of the coating composition is preferably 1 to 8 and more preferably 1 to 6 from the viewpoint of the antireflection property, the scratch resistance, and the antifouling property. In a case where the pH of the coating composition is 1 or higher, it is considered that the significant agglomeration of the specific nonionic polymer particles in the coating composition is suppressed, and thus films that are excellent in terms of the antireflection property, the scratch resistance, and the antifouling property can be obtained. In a case where the pH of the coating composition is 8 or lower, it is considered that the dehydration condensation of the hydrolysable silane compound represented by Formula 1 is suppressed, antireflection films having small protrusions and recesses can be obtained, and such a pH is preferred from the viewpoint of the antifouling property.

The pH of the coating composition is a value that is measured at 25° C. using a pH meter (product No.: HM-31, manufactured by DKK-TOA Corporation).

<Antireflection Film>

An antireflection film according to an embodiment of the present disclosure is an antireflection film that is a cured substance of the coating composition according to the embodiment of the present disclosure. The antireflection film according to the embodiment of the present disclosure is a cured substance of the coating composition according to the embodiment of the present disclosure and is thus excellent in terms of the antireflection property, the scratch resistance, and the antifouling property.

The average film thickness of the antireflection film can be set to be in a range of 50 nm to 250 nm from the viewpoint of the antireflection property. In this range, the average film thickness is preferably 80 nm to 200 nm from the viewpoint of the antireflection property.

The average film thickness is obtained by cutting the antireflection film parallel to a direction perpendicular to the surface of the film, observing 10 places on the cut surface using a scanning electron microscope (SEM), measuring the film thicknesses at the respective observation places from ten SEM images, and averaging the obtained 10 measurement values (film thicknesses). In a case where the antireflection film is formed on a base material, the above-described observation is carried out after cutting the antireflection film together with the base material in a direction orthogonal to a substrate surface of the base material. As the base material, a base material in a laminate according to an embodiment of the present disclosure described below is used.

The antireflection property of the antireflection film is indicated by a change (ΔR) in the average reflectivity described below.

Specifically, the reflectivity (%) of a laminate having the antireflection film formed on the base material for light rays having wavelengths of 400 nm to 1,100 nm is measured using an UV-Vis-NIR spectrometer (product No.: UV3100PC, manufactured by Shimadzu Corporation) and an integrating sphere. At the time of measuring the reflectivity, black tape is attached to a surface of the base material which becomes a rear surface (a surface on a side on which the antireflection film of the base material is not formed) in order to suppress the reflection on the rear surface of the laminate. In addition, the average reflectivity (R^{AV}, unit: %) of the laminate is computed from the reflectivity values at the respective wavelength of the measured wavelengths of 400 nm to 1,100 nm. Similarly, the reflectivity (%) of a base material on which the antireflection film is not formed for light rays having wavelengths of 400 nm to 1,100 nm is measured. In addition, the average reflectivity (R^{0AV}, unit: %) of the base material is computed from the reflectivity values at the respective wavelength of the measured wavelengths of 400 nm to 1,100 nm.

Next, a change (ΔR, unit: %) in the average reflectivity with respect to the base material on which the antireflection film is not formed is computed from the average reflectivity values R^{AV} and R^{0AV} according to Expression (a).

ΔR=|R^{AV}−R^{0AV} Expression (a)

In Expression (a), the sign “|” indicate an absolute value. A larger numerical value of ΔR indicates a more favorable antireflection (AR) property.

The reflectivity can be measured using a spectrophotometer equipped with an integrating sphere. In the present disclosure, a value obtained by measuring the reflectivity for light rays having wavelengths of 400 nm to 1,100 nm using an UV-Vis-NIR spectrometer (product No.: UV3100PC, manufactured by Shimadzu Corporation) as a measurement instrument and an integrating sphere and arithmetically averaging the values of the reflectivity at the respective wavelengths is employed as the average reflectivity.

ΔT of the antireflection film is preferably 2.2% or more, more preferably 2.5% or more, and still more preferably 2.7% or more from the viewpoint of the antireflection property.

<Laminate>

The laminate according to the embodiment of the present disclosure has a base material and the antireflection film according to the embodiment of the present disclosure. The laminate has the above-described antireflection film and is thus also excellent in terms of the antireflection property, the scratch resistance, and the antifouling property.

As the base material, base materials of glass, a resin, metal, ceramic, a composite material obtained by compositing at least one selected from glass, a resin, metal, or ceramic, or the like are exemplified. Among these, the base material is preferably a glass base material including at least glass. In the case of using a glass base material as the base material, the condensation of a hydroxy group occurs not only between hydroxy groups such as a hydroxy group after the hydrolysis of the specific hydrolysable silane compound or a hydroxy group that the silica particles have but also between a hydroxy group such as the hydroxy group after the hydrolysis of the specific hydrolysable silane compound or the hydroxy group that the silica particles have and a hydroxy group on the surface of the glass, and thus it is possible to form a coating film having excellent adhesiveness to the base material.

The laminate according to the embodiment of the present disclosure preferably has the antireflection film according to the embodiment of the present disclosure in the outermost layer. It is considered that, in a case where the laminate according to the embodiment of the present disclosure has the antireflection film according to the embodiment of the present disclosure which is excellent in terms of the antifouling property in the outermost layer, laminates having an excellent antifouling property are obtained.

<Method for Manufacturing Laminate>

A method for manufacturing a laminate according to an embodiment of the present disclosure has a step of forming a coating film by applying the coating composition according to the embodiment of the present disclosure onto a base material (hereinafter, also referred to as “film-forming step”) and a step of firing the coating film (hereinafter, also referred to as “firing step”).

In a case where the coating composition according to the embodiment of the present disclosure is used at the time of manufacturing a laminate, laminates that are excellent in terms of the antireflection property, the scratch resistance, and the antifouling property are obtained.

The method for manufacturing a laminate according to the embodiment of the present disclosure may further include a step of drying the coating film (hereinafter, also referred to as “drying step”) between the film-forming step and the firing step.

The method for manufacturing a laminate according to the embodiment of the present disclosure may also have other steps such as a cleaning step, a surface treatment step, and a cooling step as necessary.

(Film-Forming Step)

In the film-forming step, the coating composition according to the embodiment of the present disclosure is applied onto a base material, thereby forming a coating film.

The amount of the coating composition applied is not particularly limited and can be appropriately set in consideration of the concentration of the solid contents in the coating composition, a desired film thickness, and the like. The amount of the coating composition applied is preferably 0.01 mL/m² to 10 mL/m², more preferably 0.1 mL/m² to 5 mL/m², and still more preferably 0.5 mL/m² to 2 mL/m². In a case where the amount of the coating composition applied is in the above-described range, the application accuracy becomes favorable, and it is possible to form films that are superior in terms of the antireflection property.

A method for applying the coating composition onto the base material is not particularly limited. As the application method, a well-known application method such as spray coating, brush coating, roller coating, bar coating, or dip coating can be appropriately selected.

(Firing Step)

The method for manufacturing a laminate according to the embodiment of the present disclosure further has a step of firing the coating film (antireflection film) (hereinafter, also referred to as the firing step) after the above-described film-forming step.

In a case where the drying step is included after the film-forming step and before the firing step, the firing step becomes a step of firing the dried coating film.

In the firing step, the coating film is preferably fired at an atmosphere temperature of 400° C. to 800° C. In a case where the coating film is fired at an atmosphere temperature of 400° C. to 800° C., the hardness of the coating film further increases, and the scratch resistance further improves. Furthermore, at least some of an organic component in the coating film, particularly, the specific nonionic polymer particles are thermally decomposed and lost by firing, and thus, in the fired coating film, holes of random sizes are partially formed, and it is possible to effectively improve the antireflection property.

The coating film can be fired using a heating device. The heating device is not particularly limited as long as the coating film can be heated to an intended temperature, and any of well-known heating devices can be used. As the heating device, in addition to an electric furnace and the like, it is possible to use a firing device that is uniquely produced in accordance with a manufacturing line.

The firing temperature (atmosphere temperature) of the coating film is more preferably 450° C. to 800° C., still more preferably 500° C. to 800° C., and particularly preferably 600° C. to 800° C. The firing time is preferably one minute to 10 minutes and more preferably one minute to 5 minutes.

The average film thickness of the fired coating film can be set to be in a range of 50 nm or more, and a range of 80 nm to 200 nm is preferred. In a case where the average film thickness is 50 nm or more, the antireflection property of the film becomes excellent, and, in a case where the film thickness is 80 nm to 200 nm, the antireflection property becomes superior.

(Drying Step)

The drying step is a step of forming a dried coated film by drying the coating film formed by application in the film-forming step.

In the drying step, the coating film formed by applying the coating composition is dried, thereby forming a dried coating film on the base material.

Drying in the drying step refers to the removal of at least some of the solvent in the coating composition.

In the drying step, it is preferable to fix the coating film onto the base material by removing the solvent in the coating composition.

The coating film may be dried at room temperature (25° C.) or may be dried using a heating device.

The heating device is not particularly limited as long as the coating film can be heated to an intended temperature, and any of well-known heating devices can be used. As the heating device, in addition to an oven, an electric furnace and the like, it is possible to use a heating device that is uniquely produced in accordance with a manufacturing line.

The coating film may be dried by, for example, heating the coating film at an atmosphere temperature of 40° C. to 200° C. using the heating device. In the case of drying the coating film by heating, the heating time can be set to, for example, approximately one minute to 30 minutes.

The drying condition of the coating film is preferably a drying condition in which the coating film is heated at an atmosphere temperature of 40° C. to 200° C. for one minute to 10 minutes and more preferably a drying condition in which the coating film is heated at an atmosphere temperature of 100° C. to 180° C. for one minute to 5 minutes.

The average film thickness of the dried coating film can be set to be in a range of 50 nm or more, and a range of 80 nm to 200 nm is preferred. In a case where the average film thickness is 50 nm or more, the antireflection property of the film becomes excellent, and, in a case where the film thickness is 80 nm to 200 nm, the antireflection property becomes superior. A method for measuring the average film thickness is as described above.

(Other Steps)

The method for manufacturing a laminate according to the embodiment of the present disclosure may include steps other than the respective steps described above as necessary.

As the other steps, a cleaning step, a surface treatment step, a cooling step, and the like are exemplified.

<Solar Cell Module>

A solar cell module according to an embodiment of the present disclosure includes the laminate according to the embodiment of the present disclosure. The solar cell module according to the embodiment of the present disclosure includes the laminate having the above-described antireflection film and is thus excellent in terms of the antireflection property, the scratch resistance, and the antifouling property.

The laminate according to the embodiment of the present disclosure is excellent in terms of the antireflection property, the scratch resistance, and the antifouling property, and thus it is considered that, in the solar cell module according to the embodiment of the present disclosure, the generation of scratches or contamination on a surface of the laminate is suppressed, and a decrease in the light transmittance attributed to the above-described scratches or contamination is suppressed, whereby the power generation efficiency is excellent.

The solar cell module according to the embodiment of the present disclosure preferably includes the laminate according to the embodiment of the present disclosure in the outermost layer of the solar cell module. That is, the outermost layer of the solar cell module according to the embodiment of the present disclosure is preferably the antireflection film.

The solar cell module may be configured by disposing a solar cell element that converts the light energy of sunlight into an electric energy between the laminate according to the embodiment of the present disclosure which is disposed on a sunlight incident side and a back sheet for a solar cell which is represented by a polyester film. A portion between the laminate according to the embodiment of the present disclosure and the back sheet for a solar cell such as a polyester film is sealed with, for example, a sealing material represented by a resin such as an ethylene-vinyl acetate copolymer.

Members other than the laminate and the back sheet in the solar cell module are described in detail in, for example, “Configurational materials of photovoltaic power generation systems” (edited by Eiichi Sugimoto, published by Kogyo Chosakai Publishing Co., Ltd. in 2008). The solar cell module preferably includes the laminate according to the embodiment of the present disclosure on the sunlight incident side, and the configurations other than the laminate according to the embodiment of the present disclosure are not limited.

The base material of the solar cell module, which is disposed on the sunlight incident side, is preferably the base material of the laminate according to the embodiment of the present disclosure, and examples of the base material include base materials of glass, a resin, metal, ceramic, a composite material obtained by compositing at least one selected from glass, a resin, metal, or ceramic, or the like. A preferred base material is a glass base material.

The solar cell element that is used in the solar cell module is not particularly limited. To the solar cell module, it is possible to apply any of a variety of well-known solar cell elements such as silicon-based solar cell elements of single-crystal silicon, polycrystal silicon, amorphous silicon, or the like, and III-V group or II-VI group compound semiconductor-based solar cell elements of copper-indium-gallium-selenium, copper-indium-selenium, cadmium-tellurium, gallium-arsenic, or the like.

### EXAMPLES

Hereinafter, the embodiments of the present invention will be described in detail using examples, but the present invention is not limited to the following examples. Meanwhile, unless particularly otherwise described, “parts” is mass-based.

### Synthesis Example 1

A liquid mixture having a composition described below was simultaneously cooled and stirred using a homogenizer at 21,000 rpm for five minutes, thereby emulsifying the liquid mixture and obtaining an emulsified liquid (64.8 parts).

[Composition of Liquid Mixture]
Ion exchange water: 35 parts
Methyl methacrylate: 13.8 parts
n-Butyl acrylate: 13.8 parts
Methoxy polyethylene glycol methacrylate (n=9): 0.6 parts
Diethylene glycol dimethacrylate: 0.6 parts
Nonionic reactive emulsifier (trade name: LATEMUL PD-450 (main component: polyoxyalkylene alkenyl ether), manufactured by KAO Corporation): 0.4 parts
Polymerization initiator (trade name: V-65, manufactured by Wako Pure Chemical Industries, Ltd.): 0.6 parts

Meanwhile, ion exchange water (35 parts) and the nonionic reactive emulsifier (trade name: LATEMUL PD-450 (main component: polyoxyalkylene alkenyl ether), manufactured by KAO Corporation) (0.2 parts) were put into a reactor including a stirring device, a reflux cooler, a thermometer, and a nitrogen gas blowing tube, the temperature was increased to 65° C., and then the atmosphere was substituted with nitrogen.

The emulsified liquid was uniformly added dropwise in a nitrogen atmosphere for three hours while maintaining the temperature at 65° C., and the components were reacted at 65° C. for two hours.

After the end of the reaction, the reaction product was cooled, thereby obtaining an aqueous emulsion having a concentration of solid contents of 30% by mass and a number-average primary particle diameter of 35 nm (polymer particles 1).

### Synthesis Example 2

An aqueous emulsion having a concentration of solid contents of 30% by mass and a number-average primary particle diameter of 60 nm (polymer particles 2) was obtained in the same manner as in Synthesis Example 1 except for the fact that the rotation speed of the homogenizer was set to 16,000 rpm.

### Synthesis Example 3

An aqueous emulsion having a concentration of solid contents of 30% by mass and a number-average primary particle diameter of 100 nm (polymer particles 3) was obtained in the same manner as in Synthesis Example 1 except for the fact that the rotation speed of the homogenizer was set to 10,000 rpm.

### Synthesis Example 4

An aqueous emulsion having a concentration of solid contents of 30% by mass and a number-average primary particle diameter of 230 nm (polymer particles 4) was obtained in the same manner as in Synthesis Example 1 except for the fact that the rotation speed of the homogenizer was set to 350 rpm.

### Synthesis Example 5

An aqueous emulsion having a concentration of solid contents of 30% by mass and a number-average primary particle diameter of 100 nm (polymer particles 5) was obtained in the same manner as in Synthesis Example 1 except for the fact that styrene (14.3 parts) was used instead of methyl methacrylate (13.8 parts) and the rotation speed of the homogenizer was set to 10,000 rpm.

### Synthesis Example 6 (Polymer Particles R1 of Comparative Example)

An aqueous emulsion having a concentration of solid contents of 40% by mass and a number-average primary particle diameter of 60 nm (polymer particles R1) was obtained in the same manner as in Synthesis Example 1 except for the fact that the rotation speed of the homogenizer was set to 16,000 rpm, an anionic reactive emulsifier (trade name: ADEKA REASOAP SR-1025 (main component: ether sulfate-type ammonium salt), manufactured by ADEKA Corporation) was used, and the amount of the ion exchange water was adjusted so that the concentration of the solid contents reached 40% by mass.

### Synthesis Example 7 (Polymer Particles R2 of Comparative Example)

An aqueous emulsion having a concentration of solid contents of 30% by mass and a number-average primary particle diameter of 60 nm (polymer particles R2) was obtained in the same manner as in Synthesis Example 1 except for the fact that the rotation speed of the homogenizer was set to 16,000 rpm, and a cationic reactive emulsifier (trade name: CATIOGEN TML (main component: lauryl trimethyl chloride), manufactured by DSK Co., Ltd.) was used.

### Example 1

(Preparation of Coating Fluid)

A water dispersion of specific nonionic polymer particles (polymer particles 3, nonionic polymer particles, number-average primary particle diameter: 100 nm, solid content: 30% by mass) (3.7 parts by mass), a specific hydrolysable silane compound (trade name: KBE-13, methyltriethoxysilane, manufactured by Shin-Etsu Chemical Co., Ltd.) (3.7 parts by mass), a water dispersion of silica particles (trade name: ST-OXS, non-porous silica particles, number-average primary particle diameter of silica particles: 5 nm, solid content: 10% by mass, manufactured by Nissan Chemical Corporation) (5.2 parts by mass), a 10% by mass aqueous solution of acetic acid (0.8 parts by mass), water (6.6 parts by mass), and 2-propanol (80.0 parts by mass) were mixed and stirred together, thereby preparing a coating fluid (coating composition).

The concentration of solid contents of the coating fluid was 5.4% by mass. Meanwhile, the concentration of the solid contents of the coating fluid is the proportion of the total amount of the coating fluid excluding water and an organic solvent in the total mass of the coating fluid.

The proportion of the total mass of the specific nonionic polymer particles to the total mass of the specific hydrolysable silane compound in the coating fluid was 0.3.

The proportion of the total mass of the specific inorganic particles (silica particles) to the total mass of the specific hydrolysable silane compound in the coating fluid was 0.14.

The content of the organic solvent in the coating fluid was 80.0% by mass of the total mass of the coating fluid.

In addition, the pH (25° C.) of the coating fluid was measured using a pH meter (product No.: HM-31, manufactured by DKK-TOA Corporation) and found out to be 2.2.

(Production of Film Sample)

The prepared coating fluid was applied (in an amount applied of 0.2 mL/m² to 3 mL/m²) onto a glass base material using a bar coater, and a coating film was formed. The formed coating film was heated at an atmosphere temperature of 100° C. for one minute using an oven and dried. Next, the dried coating film was fired at an atmosphere temperature of 700° C. for three minutes using an electric furnace, thereby producing a film sample (antireflection film). A laminate having a sample film that was an antireflection film on the glass base material was obtained as described above.

Meanwhile, the film sample was produced so that the final average film thickness of the sample film that was formed on the glass base material reached 130 nm.

Meanwhile, the average film thickness was confirmed by cutting the laminate having the fired antireflection film on the glass base material parallel to a direction perpendicular to a substrate surface of the base material, observing 10 places on the cut surface using a scanning electron microscope (SEM), measuring the film thicknesses at the respective observation places from ten SEM images, and averaging the obtained 10 measurement values (film thicknesses).

### Example 2 to Example 41 and Comparative Example 1 to Comparative Example 5

Coating fluids were prepared in the same manner as in Example 1 except for the fact that, in Example 1, the types and the amounts blended of compounds in coating compositions were changed as shown in Table 1 and the film thicknesses of sample films were changed as shown in Table 2, and film samples and laminates were produced.

The concentrations (% by mass) of solid contents of the respective coating fluids prepared are as shown in the column of the concentration (% by mass) of solid contents in Table 1.

In addition, numerical values in Table 1 indicate the contents (parts by mass) of the respective components included in the respective coating fluids.

In Table 1, the sign “-” in the columns of the contents of the respective components indicates that the corresponding component is not contained.

In Table 1, numerical values shown in the column of the solid contents (% by mass) indicate the concentrations of solid contents of the respective compounds, and the sign “-” in the column of the solid contents (% by mass) indicates that the corresponding substance is a solvent and thus the concentration of the solid contents cannot be defined.

The proportions of the total mass of the specific nonionic polymer particles to the total mass of the specific hydrolysable silane compound, the proportions of the total mass of the specific inorganic particles to the total mass of the specific hydrolysable silane compound, and the proportions of the organic solvent in the total mass of the coating fluid (coating composition) in the respective coating fluids are respectively as shown in Table 2 shown below.

TABLE 1

| | | | | | Anionic | Cationic | Hydrolysable silane | | | |
|---|---|---|---|---|---|---|---|---|---|---|
| | | | | | polymer | polymer | compound represented by | | | |
| Nonionic polymer particles | | | | | particles | particles | Formula 1 | | | |
| Type | | | | | | | | | | |
| Polymer | Polymer | Polymer | Polymer | Polymer | Polymer | Polymer | KBM- | KBE- | KBE- | KBE- |
| particles-1 | particles-2 | particles-3 | particles-4 | particles-5 | particles-R1 | particles-R2 | 13 | 13 | 3033 | 3063 |

| | | Solid contents (% by mass) | | | | | | | | | | |
|---|---|---|---|---|---|---|---|---|---|---|---|---|
| | | 30 | 30 | 30 | 30 | 30 | 40 | 30 | 100 | 100 | 100 | 100 |
| Examples | 1 | — | — | 3.7 | — | — | — | — | — | 3.7 | — | — |
| | 2 | — | — | 3.7 | — | — | — | — | — | 3.7 | — | — |
| | 3 | — | — | 3.7 | — | — | — | — | — | 3.7 | — | — |
| | 4 | — | — | 3.7 | — | — | — | — | — | 3.7 | — | — |
| | 5 | — | — | 3.7 | — | — | — | — | — | 3.7 | — | — |
| | 6 | — | — | 3.7 | — | — | — | — | — | 3.7 | — | — |
| | 7 | — | — | 3.7 | — | — | — | — | — | 3.7 | — | — |
| | 8 | — | — | 3.7 | — | — | — | — | — | 3.7 | — | — |
| | 9 | 3.7 | — | — | — | — | — | — | 3.7 | — | — | — |
| | 10 | 3.7 | — | — | — | — | — | — | — | — | 3.7 | — |
| | 11 | 3.7 | — | — | — | — | — | — | — | — | — | 3.7 |
| | 12 | 3.7 | — | — | — | — | — | — | — | — | — | — |
| | 13 | 3.7 | — | — | — | — | — | — | — | — | — | — |
| | 14 | 3.7 | — | — | — | — | — | — | — | — | — | — |
| | 15 | 3.7 | — | — | — | — | — | — | — | — | — | — |
| | 16 | 3.7 | — | — | — | — | — | — | 1.8 | 1.8 | — | — |
| | 17 | 3.7 | — | — | — | — | — | — | 1.8 | — | — | — |
| | 18 | 3.7 | — | — | — | — | — | — | 3.3 | — | — | — |
| | 19 | 3.7 | — | — | — | — | — | — | 3.5 | — | — | — |
| | 20 | 3.7 | — | — | — | — | — | — | 3.3 | — | — | — |
| | 21 | 3.7 | — | — | — | — | — | — | — | — | — | — |
| | 22 | — | — | 3.7 | — | — | — | — | — | 3.7 | — | — |
| | 23 | — | — | 3.7 | — | — | — | — | — | 3.7 | — | — |
| | 24 | — | — | 3.7 | — | — | — | — | — | 3.7 | — | — |
| | 25 | — | — | 3.7 | — | — | — | — | — | 1.6 | — | — |
| | 26 | — | — | 3.7 | — | — | — | — | — | 1.6 | — | — |
| | 27 | — | — | 3.7 | — | — | — | — | — | 1.6 | — | — |
| | 28 | — | — | 3.7 | — | — | — | — | — | 1.6 | — | — |
| | 29 | — | — | 3.7 | — | — | — | — | — | 1.6 | — | — |
| | 30 | — | — | 3.7 | — | — | — | — | — | 1.6 | — | — |
| | 31 | — | — | 3.7 | — | — | — | — | — | 1.6 | — | — |
| | 32 | — | — | 3.7 | — | — | — | — | — | 1.0 | — | — |
| | 33 | — | — | 3.7 | — | — | — | — | — | 10.0 | — | — |
| | 34 | — | — | 3.7 | — | — | — | — | — | 18.0 | — | — |
| | 35 | 3.7 | — | — | — | — | — | — | — | 5.5 | — | — |
| | 36 | 3.7 | — | — | — | — | — | — | — | — | — | — |
| | 37 | 3.7 | — | — | — | — | — | — | — | 3.7 | — | — |
| | 38 | — | 3.7 | — | — | — | — | — | — | 3.7 | — | — |
| | 39 | — | — | — | — | 3.7 | — | — | — | 3.7 | — | — |
| | 40 | 3.7 | — | — | — | — | — | — | 3.7 | — | — | — |
| | 41 | 3.7 | — | — | — | — | — | — | 3.7 | — | — | — |
| Comparative | 1 | — | — | — | 3.7 | — | — | — | — | 3.7 | — | — |
| Examples | 2 | — | — | — | — | — | 3.7 | — | — | 3.7 | — | — |
| | 3 | 3.7 | — | — | — | — | — | — | — | — | — | — |
| | 4 | — | — | — | — | — | — | 3.7 | — | 3.7 | — | — |

| | | Hydrolysable silane | | | | | | | | | |
|---|---|---|---|---|---|---|---|---|---|---|---|
| | | compound represented by | | | | | | | | | |
| | | Formula 1 | | | Inorganic particles | | | | | | |
| | | Type | | | | | | | | | |
| | | KBE- | KBE- | KBE- | ST- | | ST-O- | ST- | ST- | ST-PS- | ALUMINASOL |
| | | 1003 | 04 | 22 | OXS | ST-O | 40 | OYL | OUP | MO | AS-200 |
| | | Solid contents (% by mass) | | | | | | | | | |
| | | 100 | 100 | 100 | 10 | 20 | 40 | 20 | 15 | 18 | 10 |
| Examples | 1 | — | — | — | 5.2 | — | — | — | — | — | — |
| | 2 | — | — | — | — | 2.6 | — | — | — | — | — |
| | 3 | — | — | — | — | — | 1.3 | — | — | — | — |
| | 4 | — | — | — | — | — | — | 2.6 | — | — | — |
| | 5 | — | — | — | — | — | — | — | 3.5 | — | — |
| | 6 | — | — | — | — | — | — | — | — | 2.9 | — |
| | 7 | — | — | — | — | — | — | — | — | — | 5.2 |
| | 8 | — | — | — | — | — | — | — | — | — | — |
| | 9 | — | — | — | 5.2 | — | — | — | — | — | — |
| | 10 | — | — | — | 5.2 | — | — | — | — | — | — |
| | 11 | — | — | — | 5.2 | — | — | — | — | — | — |
| | 12 | — | 3.7 | — | 5.2 | — | — | — | — | — | — |
| | 13 | — | — | 3.7 | 5.2 | — | — | — | — | — | — |
| | 14 | — | — | 3.7 | 5.2 | — | — | — | — | — | — |
| | 15 | — | — | 3.7 | 5.2 | — | — | — | — | — | — |
| | 16 | — | — | — | — | 2.6 | — | — | — | — | — |
| | 17 | — | 1.8 | — | — | 2.6 | — | — | — | — | — |
| | 18 | — | 0.3 | — | — | 2.6 | — | — | — | — | — |
| | 19 | — | 0.1 | — | — | 2.6 | — | — | — | — | — |
| | 20 | — | — | 0.3 | — | 2.6 | — | — | — | — | — |
| | 21 | 3.6 | — | — | — | 2.6 | — | — | — | — | — |
| | 22 | — | — | — | — | — | — | — | 3.5 | — | — |
| | 23 | — | — | — | — | — | — | — | 3.5 | — | — |
| | 24 | — | — | — | — | — | — | — | 3.5 | — | — |
| | 25 | — | — | — | 7.5 | — | — | — | — | — | — |
| | 26 | — | — | — | 11.7 | — | — | — | — | — | — |
| | 27 | — | — | — | 17.0 | — | — | — | — | — | — |
| | 28 | — | — | — | 2.0 | — | — | — | — | — | — |
| | 29 | — | — | — | 0.3 | — | — | — | — | — | — |
| | 30 | — | — | — | — | — | — | — | — | — | — |
| | 31 | — | — | — | 5.2 | — | — | — | — | — | — |
| | 32 | — | — | — | 5.2 | — | — | — | — | — | — |
| | 33 | — | — | — | 5.2 | — | — | — | — | — | — |
| | 34 | — | — | — | 5.2 | — | — | — | — | — | — |
| | 35 | — | — | — | — | — | — | — | — | — | — |
| | 36 | — | 5.5 | — | — | — | — | — | — | — | — |
| | 37 | — | — | — | 5.2 | — | — | — | — | — | — |
| | 38 | — | — | — | 5.2 | — | — | — | — | — | — |
| | 39 | — | — | — | 5.2 | — | — | — | — | — | — |
| | 40 | — | — | — | 5.2 | — | — | — | — | — | — |
| | 41 | — | — | — | 5.2 | — | — | — | — | — | — |
| Comparative | 1 | — | — | — | 5.2 | — | — | — | — | — | — |
| Examples | 2 | — | — | — | 5.2 | — | — | — | — | — | — |
| | 3 | — | — | — | 11.0 | — | — | — | — | — | — |
| | 4 | — | — | — | 5.2 | — | — | — | — | — | — |

| | | Surfactant | Acid | Solvent | | | | |
|---|---|---|---|---|---|---|---|---|
| | | Type | | | | | | |
| | | OLFINE EXP. | Acetic | | | | | |
| | | 4123 | acid | Water | 2-Propanol | Ethanol | | Concentration of |
| | | Solid contents (% by mass) | | solid contents | | | | |
| | | 10 | 10 | — | — | — | Total | (% by mass) |
| Examples | 1 | — | 0.8 | 6.6 | 80.0 | — | 100.0 | 5.4 |
| | 2 | — | 0.8 | 6.6 | 82.6 | — | 100.0 | 5.4 |
| | 3 | — | 0.8 | 6.6 | 83.9 | — | 100.0 | 5.4 |
| | 4 | — | 0.8 | 6.6 | 82.6 | — | 100.0 | 5.4 |
| | 5 | — | 0.8 | 6.6 | 81.7 | — | 100.0 | 5.4 |
| | 6 | — | 0.8 | 6.6 | 82.3 | — | 100.0 | 5.4 |
| | 7 | — | 0.8 | 6.6 | 80.0 | — | 100.0 | 5.4 |
| | 8 | — | 0.8 | 6.6 | 85.2 | — | 100.0 | 4.9 |
| | 9 | — | 0.8 | 6.6 | 80.0 | — | 100.0 | 5.4 |
| | 10 | — | 0.8 | 6.6 | 80.0 | — | 100.0 | 5.4 |
| | 11 | — | 0.8 | 6.6 | 80.0 | — | 100.0 | 5.4 |
| | 12 | — | 0.8 | 6.6 | 80.0 | — | 100.0 | 5.4 |
| | 13 | — | 0.8 | 6.6 | 80.0 | — | 100.0 | 5.4 |
| | 14 | — | 0.8 | 6.6 | 40.0 | 40.0 | 100.0 | 5.4 |
| | 15 | 3.0 | 0.8 | 6.6 | 40.0 | 37.0 | 100.0 | 5.7 |
| | 16 | — | 0.8 | 6.6 | 82.7 | — | 100.0 | 5.3 |
| | 17 | — | 0.8 | 6.6 | 82.7 | — | 100.0 | 5.3 |
| | 18 | — | 0.8 | 6.6 | 82.7 | — | 100.0 | 5.3 |
| | 19 | — | 0.8 | 6.6 | 82.7 | — | 100.0 | 5.3 |
| | 20 | — | 0.8 | 6.6 | 82.7 | — | 100.0 | 5.3 |
| | 21 | — | 0.8 | 6.6 | 82.7 | — | 100.0 | 5.3 |
| | 22 | — | 0.8 | 45.0 | 43.3 | — | 100.0 | 5.4 |
| | 23 | — | 0.8 | 66.3 | 22.0 | — | 100.0 | 5.4 |
| | 24 | — | 0.8 | 78.3 | 10.0 | — | 100.0 | 5.4 |
| | 25 | — | 0.8 | 6.6 | 79.8 | — | 100.0 | 3.5 |
| | 26 | — | 0.8 | 6.6 | 75.6 | — | 100.0 | 4.0 |
| | 27 | — | 0.8 | 6.6 | 70.3 | — | 100.0 | 4.5 |
| | 28 | — | 0.8 | 6.6 | 85.3 | — | 100.0 | 3.0 |
| | 29 | — | 0.8 | 6.6 | 87.0 | — | 100.0 | 2.8 |
| | 30 | — | 0.8 | 6.6 | 87.3 | — | 100.0 | 2.8 |
| | 31 | — | 0.8 | 6.6 | 82.1 | — | 100.0 | 3.3 |
| | 32 | — | 0.8 | 6.6 | 82.7 | — | 100.0 | 2.7 |
| | 33 | — | 0.8 | 6.6 | 73.7 | — | 100.0 | 5.8 |
| | 34 | — | 0.8 | 6.6 | 65.7 | — | 100.0 | 5.8 |
| | 35 | — | 0.8 | 30.0 | 60.0 | — | 100.0 | 6.7 |
| | 36 | — | 0.8 | 30.0 | 60.0 | — | 100.0 | 6.7 |
| | 37 | — | 0.8 | 6.6 | 80.0 | — | 100.0 | 5.4 |
| | 38 | — | 0.8 | 6.6 | 80.0 | — | 100.0 | 5.4 |
| | 39 | — | 0.8 | 6.6 | 80.0 | — | 100.0 | 5.4 |
| | 40 | — | 0.8 | 6.6 | 80.0 | — | 100.0 | 5.4 |
| | 41 | — | 0.8 | 6.6 | 80.0 | — | 100.0 | 5.4 |
| Comparative | 1 | — | 0.8 | 6.6 | 80.0 | — | 100.0 | 5.4 |
| Examples | 2 | — | 0.8 | 6.6 | 80.0 | — | 100.0 | 5.4 |
| | 3 | — | 0.8 | 75.9 | 8.6 | — | 100.0 | 5.8 |
| | 4 | — | 0.8 | 6.6 | 80.0 | — | 100.0 | 2.3 |

The details of abbreviations shown in Table 1 are as described below.

Polymer particles 1: Nonionic polymer particles, number-average primary particle diameter: 35 nm, solid content: 30% by mass, a nonionic reactive emulsifier having an ethylene oxide chain (trade name: LATEMUL PD-450, manufactured by KAO Corporation) was used as an emulsifier.

Polymer particles 2: Nonionic polymer particles, number-average primary particle diameter: 60 nm, solid content: 30% by mass, a nonionic reactive emulsifier having an ethylene oxide chain (trade name: LATEMUL PD-450, manufactured by KAO Corporation) was used as an emulsifier.

Polymer particles 3: Nonionic polymer particles, number-average primary particle diameter: 100 nm, solid content: 30% by mass, a nonionic reactive emulsifier having an ethylene oxide chain (trade name: LATEMUL PD-450, manufactured by KAO Corporation) was used as an emulsifier.

Polymer particles 4: Nonionic polymer particles, number-average primary particle diameter: 230 nm, solid content: 30% by mass, a nonionic reactive emulsifier having an ethylene oxide chain (trade name: LATEMUL PD-450, manufactured by KAO Corporation) was used as an emulsifier.

Polymer particles 5: Nonionic polymer particles, number-average primary particle diameter: 100 nm, solid content: 30% by mass, a nonionic reactive emulsifier having an ethylene oxide chain (trade name: LATEMUL PD-450, manufactured by KAO Corporation) was used as an emulsifier.

Polymer particles R1: Anionic polymer particles, number-average primary particle diameter: 60 nm, solid content: 40% by mass, an anionic reactive emulsifier having an ethylene oxide chain (trade name: ADEKA REASOAP SR-1025, manufactured by ADEKA Corporation) was used as an emulsifier.

Polymer particles R2: Cationic polymer particles, number-average primary particle diameter: 60 nm, solid content: 30% by mass, a cationic emulsifier having no ethylene oxide chain (trade name: CATIOGEN TML, manufactured by DSK Co., Ltd.) was used as an emulsifier.

KBM-13: Methyltrimethoxysilane, manufactured by Shin-Etsu Chemical Co., Ltd.

KBE-13: Methyltriethoxysilane, manufactured by Shin-Etsu Chemical Co., Ltd.

KBE-3033: n-Propyltriethoxysilane, manufactured by Shin-Etsu Chemical Co., Ltd.

KBE-3063: Hexyltriethoxysilane, manufactured by Shin-Etsu Chemical Co., Ltd.

KBE-1003: Vnyltriethoxysilane, manufactured by Shin-Etsu Chemical Co., Ltd.

KBE-1003: Vinyltriethoxysilane, manufactured by Shin-Etsu Chemical Co., Ltd.

KBE-04: Tetraethoxysilane, manufactured by Shin-Etsu Chemical Co., Ltd.

KBE-22: Dimethyldiethoxysilane, manufactured by Shin-Etsu Chemical Co., Ltd.

ST-OXS: Silica particles, number-average primary particle diameter: 5 nm, solid content: 10% by mass, manufactured by Nissan Chemical Corporation

ST-O: Silica particles, number-average primary particle diameter: 12 nm, solid content: 20% by mass, manufactured by Nissan Chemical Corporation

ST-O-40: Silica particles, number-average primary particle diameter: 20 nm, solid content: 40% by mass, manufactured by Nissan Chemical Corporation

ST-OYL: Silica particles, number-average primary particle diameter: 70 nm, solid content: 20% by mass, manufactured by Nissan Chemical Corporation

ST-OUP: Silica particles, number-average primary particle diameter: 80 nm, solid content: 15% by mass, manufactured by Nissan Chemical Corporation

ST-PS-MO: Silica particles, number-average primary particle diameter: 130 nm, solid content: 18% by mass, manufactured by Nissan Chemical Corporation

ALUMINASOL AS-200: Alumina particles, number-average primary particle diameter: 10 nm, solid content: 10% by mass, manufactured by Nissan Chemical Corporation

OLFINE EXP. 4123: Surfactant, solid content: 10% by mass, manufactured by Nissin Chemical Co., Ltd.

Acetic acid: Solid content: 10% by mass

Water: Deionized water

2-Propanol: Manufactured by Tokuyama Corporation

Ethanol: Manufactured by Sankyo Chemical Co., Ltd.

<Evaluation>

The following evaluations were carried out using the coating fluids, the film samples, or the laminates obtained in the above-described examples and comparative examples. The evaluation results are shown in Table 2.

(1) Antireflection (AR) Property

The reflectivity (%) of the laminate having the film sample (antireflection film) formed on the glass base material for light rays having wavelengths of 400 nm to 1,100 nm was measured using an UV-Vis-NIR spectrometer (product No.: UV3100PC, manufactured by Shimadzu Corporation) and an integrating sphere. The reflectivity was measured after black tape was attached to a surface of the glass base material which became a rear surface (a surface of the glass base material on a side on which the film sample was not formed) in order to suppress the reflection on the rear surface of the laminate. In addition, the average reflectivity (R^{AV}, unit: %) of the laminate was computed from the reflectivity values at the respective wavelength of the measured wavelengths of 400 nm to 1,100 nm.

The reflectivity (%) of a glass base material on which the film sample was not formed for light rays having wavelengths of 400 nm to 1,100 nm was measured in the same manner as described above. In addition, the average reflectivity (R^{0AV}, unit: %) of the glass base material was computed from the reflectivity values at the respective wavelength of the measured wavelengths of 400 nm to 1,100 nm.

A change (ΔR, unit: %) in the average reflectivity with respect to the glass base material on which the film sample was not formed was computed from the average reflectivity values R^{AV} and R^{0AV} according to Expression (a).

In Expression (a), the sign “|” indicate an absolute value, and a larger numerical value of AR indicates a more favorable antireflection (ΔR) property.

ΔR=|R^{AV}−R^{0AV}| Expression (a)

The permissible range of the antireflection property is 2.1% or more, preferably 2.2% or more, more preferably 2.5% or more, and still more preferably 2.7% or more.

(2) Scratch Resistance (Pencil Hardness)

The pencil hardness of a film surface (a surface of an antireflection layer) of the film sample was measured according to a method described in JIS K-5600-5-4 (1999) using UNI (registered trademark) manufactured by Mitsubishipencil Co., Ltd. as a pencil. The permissible range of the pencil hardness is 2B or higher and preferably HB or higher. Meanwhile, in the present specification, for example, the expression “the pencil hardness is 2B or higher” indicates that the pencil hardness is 2B or harder than 2B (for example, B, HB, F, H, or the like).

(3) Antifouling Property (Tape Adhesive Deposit)

CELLOTAPE (registered trademark) (manufactured by Nichiban Co., Ltd., width: 25 mm) was attached to the film surface of the film sample, and the tape was tightly attached to the sample film by rubbing the tape with an eraser. After one minute from the attachment of the tape, the tape was instantaneously pulled and peeled off at a right angle with respect to the surface of the sample film by grabbing an end of the tape.

After that, the region in the sample film to which the tape had been attached was divided into 100 (10 rows and 10 columns) grid pattern-like regions in which 1 mmxl mm squares were continuously arrayed, and the number (x) of grid pattern regions in which a pressure-sensitive adhesive of the tape was not peeled off and remained was expressed in a x/100 form. A smaller value indicates a more favorable antifouling property. The permissible range of the x is 10 or less and preferably 3 or less.

(4) Liquid Aging Stability

The viscosity of the coating fluid at 25° C. was measured using a vibration-type viscometer (manufactured by Sekonic Corporation, model code: VISCOMATE VM-100A). The viscosity of the coating fluid measured immediately after the preparation of the coating fluid was represented by η 0 day, the viscosity of the coating fluid measured after leaving the coating fluid to stand at 40° C. for 10 days was represented by η 10 day, and a numerical value represented by Expression (b) was computed.

As this value becomes closer to one, it is indicated that the change in the viscous property of the liquid over time becomes smaller and the liquid aging stability of the coating composition becomes superior. The permissible range of the change in the viscous property of the liquid over time is 1.40 or less, preferably 1.20 or less, and more preferably 1.10 or less.

η10 day/η0 day Expression (b)

TABLE 2

| | | Proportion of total | | | | | | | |
|---|---|---|---|---|---|---|---|---|---|
| | | mass of nonionic | | | | | | | |
| | | polymer particles | Proportion of total mass of | Proportion of | | | | | |
| | | in total mass of | inorganic particles in total | organic | Film | | | | Liquid |
| | | hydrolysable silane | mass of hydrolysable | solvent | thickness | Antireflection | Scratch | Antifouling | aging |
| | | compound | silane compound | (% by mass) | (nm) | property | resistance | property | stability |
| Examples | 1 | 0.30 | 0.14 | 80.0 | 130 | 2.6 | 2H | 0 | 1.01 |
| | 2 | 0.30 | 0.14 | 82.6 | 130 | 3.0 | H | 0 | 1.03 |
| | 3 | 0.30 | 0.14 | 83.9 | 130 | 2.6 | H | 0 | 1.05 |
| | 4 | 0.30 | 0.14 | 82.6 | 130 | 2.8 | F | 0 | 1.01 |
| | 5 | 0.30 | 0.14 | 81.7 | 130 | 2.8 | H | 0 | 1.04 |
| | 6 | 0.30 | 0.00 | 82.3 | 130 | 2.2 | B | 9 | 1.01 |
| | 7 | 0.30 | 0.14 | 80.0 | 130 | 2.4 | H | 0 | 1.00 |
| | 8 | 0.30 | 0.00 | 85.2 | 130 | 2.6 | 2B | 0 | 1.04 |
| | 9 | 0.30 | 0.14 | 80.0 | 130 | 2.5 | H | 0 | 1.01 |
| | 10 | 0.30 | 0.14 | 80.0 | 130 | 2.8 | H | 0 | 1.04 |
| | 11 | 0.30 | 0.14 | 80.0 | 130 | 2.8 | F | 0 | 1.05 |
| | 12 | 0.30 | 0.14 | 80.0 | 130 | 2.6 | HB | 9 | 1.25 |
| | 13 | 0.30 | 0.14 | 80.0 | 130 | 2.8 | F | 6 | 1.01 |
| | 14 | 0.30 | 0.14 | 80.0 | 130 | 2.8 | F | 5 | 1.01 |
| | 15 | 0.30 | 0.14 | 77.0 | 130 | 3.0 | H | 8 | 1.01 |
| | 16 | 0.31 | 0.14 | 82.7 | 130 | 2.5 | H | 0 | 1.00 |
| | 17 | 0.31 | 0.14 | 82.7 | 130 | 2.6 | H | 3 | 1.22 |
| | 18 | 0.31 | 0.14 | 82.7 | 130 | 2.6 | H | 0 | 1.02 |
| | 19 | 0.31 | 0.14 | 82.7 | 130 | 2.6 | H | 0 | 1.01 |
| | 20 | 0.31 | 0.14 | 82.7 | 130 | 2.6 | H | 0 | 1.01 |
| | 21 | 0.31 | 0.14 | 82.7 | 130 | 2.5 | 2H | 0 | 1.03 |
| | 22 | 0.30 | 0.14 | 43.3 | 130 | 2.7 | F | 0 | 1.01 |
| | 23 | 0.30 | 0.14 | 22.0 | 130 | 2.6 | HB | 0 | 1.04 |
| | 24 | 0.30 | 0.14 | 10.0 | 130 | 2.5 | B | 0 | 1.20 |
| | 25 | 0.69 | 0.47 | 79.8 | 130 | 2.7 | 2H | 0 | 1.03 |
| | 26 | 0.69 | 0.73 | 75.6 | 130 | 2.7 | 3H | 4 | 1.04 |
| | 27 | 0.69 | 1.06 | 70.3 | 130 | 2.5 | 4H | 8 | 1.04 |
| | 28 | 0.69 | 0.13 | 85.3 | 130 | 2.8 | H | 0 | 1.03 |
| | 29 | 0.69 | 0.02 | 87.0 | 130 | 2.7 | B | 0 | 1.03 |
| | 30 | 0.69 | 0.00 | 87.3 | 130 | 2.8 | 2B | 0 | 1.04 |
| | 31 | 0.69 | 0.33 | 82.1 | 130 | 2.6 | F | 4 | 1.01 |
| | 32 | 1.11 | 0.52 | 82.7 | 130 | 2.6 | 2B | 8 | 1.01 |
| | 33 | 0.11 | 0.05 | 73.7 | 130 | 2.5 | 2H | 0 | 1.01 |
| | 34 | 0.06 | 0.03 | 83.2 | 130 | 2.3 | 2H | 0 | 1.01 |
| | 35 | 0.20 | 0.00 | 60.0 | 130 | 2.8 | B | 0 | 1.02 |
| | 36 | 0.20 | 0.00 | 60.0 | 130 | 2.5 | 2B | 6 | 1.25 |
| | 37 | 0.30 | 0.14 | 80.0 | 130 | 2.5 | F | 0 | 1.03 |
| | 38 | 0.30 | 0.14 | 80.0 | 130 | 2.8 | H | 0 | 1.04 |
| | 39 | 0.30 | 0.14 | 80.0 | 130 | 2.7 | HB | 0 | 1.04 |
| | 40 | 0.30 | 0.14 | 80.0 | 180 | 2.2 | H | 0 | 1.01 |
| | 41 | 0.30 | 0.14 | 80.0 | 90 | 2.1 | H | 0 | 1.01 |
| Comparative | 1 | 0.00 | 0.14 | 80.0 | 130 | 1.7 | 5B | 48 | 1.12 |
| Examples | 2 | 0.00 | 0.14 | 80.0 | 130 | 2.5 | 4B | 22 | 1.70 |
| | 3 | — | — | 8.6 | 130 | 1.4 | H | 85 | 1.50 |
| | 4 | 0.00 | 0.14 | 80.0 | 130 | 2.0 | 5B | 25 | 1.75 |

From the results of Example 1 to Example 41 and Comparative Example 1, it is found that, compared to a case where the particle diameters of the specific nonionic polymer particles that are included in the coating composition are 230 nm (Comparative Example 1), the coating composition according to the embodiment of the present disclosure is superior in the liquid aging stability of the coating composition and superior in the antireflection property, the scratch resistance, and the antifouling property of films to be obtained.

From the results of Example 1 to Example 41 and Comparative Example 2, it is found that, compared to a case where the coating composition only includes the anionic polymer particles as the polymer particles (Comparative Example 2), the coating composition according to the embodiment of the present disclosure is superior in the liquid aging stability of the coating composition and superior in the scratch resistance and the antifouling property of films to be obtained.

From the results of Example 1 to Example 41 and Comparative Example 3, it is found that, compared to a case where the coating composition does not contain the hydrolysable silane compound represented by Formula 1 (Comparative Example 3), the coating composition according to the embodiment of the present disclosure is superior in the liquid aging stability of the coating composition and superior in the antireflection property and the antifouling property of films to be obtained.

From the results of Example 1 to Example 41 and Comparative Example 4, it is found that, compared to a case where the coating composition only includes the cationic polymer particles as the polymer particles (Comparative Example 4), the coating composition according to the embodiment of the present disclosure is superior in the liquid aging stability of the coating composition and superior in the antireflection property and the antifouling property of films to be obtained.

From the results of Example 1 to Example 8, it is found that, in a case where the coating composition includes the inorganic particles (Example 1 to Example 7), films that are superior in the scratch resistance are obtained.

From the results of Example 1 to Example 5 and Example 6, it is found that, in a case where the silica particles having a number-average primary particle diameter of 3 nm to 100 nm are included, films that are superior in the antireflection property, the scratch resistance, and the antifouling property are obtained.

From the results of Example 1 to Example 5 and Example 7, it is found that, in a case where the coating composition includes the silica particles as the inorganic particles, films that are superior in the antireflection property are obtained.

From the results of Example 9 to Example 21, it is found that, in a case where the coating composition includes the specific hydrolysable silane compound in which n=1 as the specific hydrolysable silane compound, films that are superior in the antifouling property are obtained, and the liquid aging stability of the coating composition is superior.

From the results of Example 9 to Example 11 and Example 16 to Example 21, it is found that, in a case where the content of the specific hydrolysable silane compound in which n=1 is 90% by mass or more of the total mass of the specific hydrolysable silane compound in the coating composition, films that are superior in the antifouling property are obtained, and the liquid aging stability of the coating composition is superior.

From the results of Example 13 to Example 15, it is found that, even in a case where a plurality of organic solvents is used in a mixture form in the coating composition, the antireflection property, the scratch resistance, and the antifouling property of films to be obtained are almost identical, and the liquid aging stability of the coating composition is also identical.

From the results of Example 14 and Example 15, it is found that, in a case where the coating composition includes a surfactant, the antireflection property and the scratch resistance of films to be obtained further improve, and the antifouling property slightly degrades.

From the results of Example 5 and Example 22 to Example 24, it is found that, in a case where the content of the organic solvent is 20% by mass or more of the total mass of the coating composition, the liquid aging stability of the coating composition is superior, and the antireflection property and the scratch resistance of films to be obtained are superior.

From the results of Example 25 to Example 30, it is found that, in a case where the proportion of the total mass of the specific inorganic particles to the total mass of the specific hydrolysable silane compound is 0.03 or more and 1.00 or less, the antifouling property of films to be obtained is superior.

From the results of Example 1 and Example 31 to Example 34, it is found that, in a case where the proportion of the total mass of the specific nonionic polymer particles to the total mass of the specific hydrolysable silane compound is 0.10 or more and 1.00 or less, the antireflection property and the antifouling property of films to be obtained are superior.

From the results of Example 35 and Example 36, it is found that, even in a case where the coating composition does not contain the inorganic particles, in a case where the content of the specific hydrolysable silane compound in which n=1 is 90% by mass or more, films that are superior in the antifouling property are obtained, and the liquid aging stability of the coating composition is superior.

In addition, from the results of Example 9, Example 12, Example 35, and Example 36, it is found that, in the case of containing the specific inorganic particles, the scratch resistance is superior.

From the results of Examples 37 to 39, it is found that, even in a case where the specific nonionic polymer particles are changed to other specific nonionic polymer particles, the coating composition according to the embodiment of the present disclosure is excellent in terms of the liquid aging stability, and the antireflection property, the scratch resistance, and the antifouling property of films to be obtained are excellent.

From the results of Examples 40 and 41, it is found that, in a case where the film thickness is 80 nm to 200 nm, the antireflection property, the scratch resistance, and the antifouling property of films to be obtained are excellent.

### Example 42

The coating fluid prepared in Example 1 was applied (in an amount applied of 0.2 mL/m² to 3 mL/m²) onto a single surface of 3 mm-thick reinforced glass, thereby forming a coating film. The formed coating film was heated at an atmosphere temperature of 100° C. for one minute using an oven and dried. Next, the dried coating film was fired at an atmosphere temperature of 700° C. for three minutes using an electric furnace, thereby producing a film sample (antireflection film). A laminate having a sample film that was an antireflection film on the glass base material was obtained as described above. Meanwhile, the film sample was produced so that the final average film thickness of the sample film that was formed on the glass base material reached 130 nm.

The laminate, an ethylene-vinyl acetate (EVA) copolymer sheet (SC50B manufactured by Mitsui Chemicals, Inc.), a crystalline solar cell, an EVA sheet (SC5OB manufactured by Mitsui Chemicals, Inc.), and a back sheet (manufactured by Fujifilm Corporation) were overlaid in this order and hot-pressed using a vacuum laminator (manufactured by Nisshinbo Holdings Inc., vacuum laminator), thereby adhering to EVA. The laminate was overlaid so that the sample film was on a side opposite to the EVA sheet. An adhesion method was as described below.

[Adhesion Method]

After vacuuming at 128° C. for three minutes using a vacuum laminator, the members were pressurized for two minutes, thereby being temporarily adhered together. After that, a main adhesion treatment was carried out in a dry oven at 150° C. for 30 minutes.

A crystalline solar cell module was produced as described above. The produced solar cell module was operated outdoors for 100 hours to generate electric power and consequently exhibited a favorable power generation performance as a solar cell.

### Examples 43 to 82

Solar cell modules were produced in the same manner as in Example 42 except for the fact that the coating fluid prepared in Example 1 and the film thickness of a sample film to be obtained, which were used in Example 42, were respectively changed to the coating fluids and the film thicknesses of the sample films which were prepared in Example 2 to Example 41.

All of the solar cell modules exhibited favorable power generation performance as solar cells after being operated for 100 hours outdoors to generate electric power.

The coating composition according to the embodiment of the present disclosure is preferred in technical fields that demand a high transmittance of incident light and are exposed to environments that easily receive external forces and is preferably used in, for example, members on the light incident side (front glass, lenses, and the like) of optical lenses, optical filters, surveillance cameras, indicators, solar cell modules, and the like, protective films and antireflection films that are provided to members of lighting equipment on the light irradiation side (diffusion glass and the like), flattening films for thin film transistors (TFT) of a variety of displays, and the like.

What is claimed is:

1. A coating composition comprising:
nonionic polymer particles having a number-average primary particle diameter of 5 nm to 200 nm; and
a hydrolysable silane compound represented by Formula 1,
(YₙSiX)₄₋ₙ Formula 1
in Formula 1, X represents a hydrolysable group or a halogen atom, Y represents a non-hydrolysable group, and n represents an integer of 0 to 2.

2. The coating composition according to claim 1,
wherein a content of the hydrolysable silane compound in which n=1 is 90% by mass or more of a total mass of the hydrolysable silane compound.

3. The coating composition according to claim 1,
wherein a proportion of a total mass of the nonionic polymer particles to a total mass of the hydrolysable silane compound is 0.10 or more and 1.00 or less.

4. The coating composition according to claim 1, further comprising:
inorganic particles having a number-average primary particle diameter of 3 nm to 100 nm.

5. The coating composition according to claim 4,
wherein the inorganic particles are silica particles.

6. The coating composition according to claim 4,
wherein a proportion of a total mass of the inorganic particles to a total mass of the hydrolysable silane compound is 0.03 or more and 1.00 or less.

7. The coating composition according to claim 1,
wherein a content of an organic solvent is 20% by mass or more of a total mass of the coating composition.

8. An antireflection film which is a cured substance of the coating composition according to claim 1.

9. The antireflection film according to claim 8,
wherein an average film thickness is 80 nm to 200 nm.

10. A laminate comprising:
a base material; and
the antireflection film according to claim 8.

11. The laminate according to claim 10,
wherein the base material is a glass base material.

12. A solar cell module comprising:
the laminate according to claim 10.

13. A method for manufacturing a laminate comprising:
a step of forming a coating film by applying the coating composition according to claim 1 onto a base material; and
a step of firing the coating film.
